(19) United States
(12) Patent Application Publication
(10) Pub. No.: US 2026/0147813 A1
(43) Pub. Date: May 28, 2026

(54) INFORMATION PROCESSING SYSTEM, INFORMATION PROCESSING APPARATUS, INFORMATION PROCESSING METHOD, AND COMPUTER-READABLE STORAGE MEDIUM

(71) Applicant: Preferred Networks, Inc., Tokyo (JP)

(72) Inventors: Masaaki FUKUDA, Tokyo (JP); Yura AOYAMA, Tokyo (JP); Motoki SATO, Tokyo (JP)

(21) Appl. No.: 19/177,961

(22) Filed: Apr. 14, 2025

(30) Foreign Application Priority Data
Apr. 19, 2024 (JP) 2024-068547

(51) Int. Cl. G06F 16/335; G06F 16/334

(52) U.S. Cl. CPC G06F 16/335; G06F 16/334

(57) ABSTRACT

An information processing system includes at least one memory, and at least one processor. The at least one processor is configured to acquire one or more pieces of reference information used for generating output information based on user information, generate input information to a machine learning model based on the one or more pieces of reference information, and generate the output information by inputting the input information to the machine learning model.

### CROSS-REFERENCE TO RELATED APPLICATIONS

This application is based upon and claims priority to Japanese Patent Application No. 2024-068547, filed on Apr. 19, 2024, the entire contents of which are incorporated herein by reference.

### BACKGROUND

### 1. Field of the Invention

The present disclosure relates to information processing systems, information processing apparatuses, information processing methods, and computer-readable storage media.

### 2. Description of the Related Art

Foundation models, such as Large Language Models (LLMs) or the like, are known. The foundation model is a machine learning model that can execute various tasks by learning large datasets. The foundation model executes the task according to input information called prompts, and outputs data generated as a result of executing the task.

In order to obtain a good output result from the foundation model, there is a known technique that obtains reference information by searching a predetermined data source and includes the reference information in the prompt. This type of technique is called Retrieval Augmented Generation (RAG) or the like.

Related art includes Patrick Lewis et al., “Retrieval-Augmented Generation for Knowledge-Intensive NLP Tasks”, [online], [retrieved on Dec. 20, 2023], Internet <URL: https://arxiv.org/pdf/2005.11401v4.pdf>, for example.

### SUMMARY

An object according to one aspect of the present disclosure is to provide a technique capable of acquiring desired output information.

According to one aspect of the present disclosure, an information processing system includes at least one memory, and at least one processor, wherein the at least one processor is configured to acquire one or more pieces of reference information used for generating output information, based on user information; generate input information to a machine learning model, based on the one or more pieces of reference information; and generate the output information by inputting the input information to the machine learning model.

The object and advantages of the embodiments will be realized and attained by means of the elements and combinations particularly pointed out in the claims.

It is to be understood that both the foregoing general description and the following detailed description are exemplary and explanatory and not restrictive of the invention, as claimed.

### BRIEF DESCRIPTION OF THE DRAWINGS

FIG. 1 is a block diagram illustrating an example of an overall configuration of an information processing system;

FIG. 2 is a block diagram illustrating an example of a functional configuration of a report apparatus;

FIG. 3 is a diagram illustrating an example of a template;

FIG. 4 is a diagram illustrating a first example of a format specifying screen;

FIG. 5 is a diagram illustrating a second example of the format specifying screen;

FIG. 6 is a diagram illustrating an example of a condition setting screen;

FIG. 7 is a diagram illustrating an example of a selection screen;

FIG. 8 is a diagram illustrating an example of a display screen;

FIG. 9 is a flow chart illustrating an example of a report generation process according to a first embodiment;

FIG. 10 is a flow chart illustrating an example of the report generation process according to a second embodiment; and

FIG. 11 is a block diagram illustrating an example of a hardware configuration of a computer.

### DETAILED DESCRIPTION

Hereinafter, embodiments of the present disclosure will be described with reference to the accompanying drawings. In the present specification and drawings, constituent elements or components having substantially the same functional configuration are designated by the same reference numerals, and a redundant description thereof will be omitted.

### First Embodiment

A first embodiment of the present disclosure relates to an information processing system configured to generate various reports based on a foundation model. In the present embodiment, the foundation model may be a Large Language Model (LLM), for example. The foundation model is not limited to the LLM, and may be a generative model that generates various data, such as audio, images, videos, or the like. The present embodiment is not limited to the foundation model, and may be configured using a machine learning model. The machine learning model may include a foundation model, a generative model, or a neural network, for example. The machine learning model supports multimodal capabilities.

The information processing system according to the present embodiment executes a generative task according to a retrieval augmented generation framework. In the present embodiment, the generative task may be a task for generating a report, for example. The report may be a report for sharing information within an organization, such as a company, a municipality, a school, or the like, for example. The report may be a report for providing information to the outside of the organization, for example. The report may be a research report reporting research results, for example. The report may be a document including information desired by a user.

The retrieval augmented generation is a technique used to obtain good generative results from the foundation model. In the retrieval augmented generation, reference information is searched from a predetermined data source based on instruction information instructing execution of a task, and a prompt including the instruction information and a search result for the reference information is input to the foundation model. Because the foundation model executes the task while taking into consideration the reference information that is not included in training data, for example, the foundation model can generate appropriate data with respect to the instruction information.

The present embodiment provides a technique capable of acquiring desired output information in the retrieval augmented generation framework. In the present embodiment, the output information according to an output format is generated, by including information related to the output format and the reference information searched based on the input information, in input information to the foundation model. According to one aspect of the present embodiment, the output format can be modified by a simple operation, and thus, it is possible to easily acquire the desired output information.

### Overall Configuration of Information Processing System

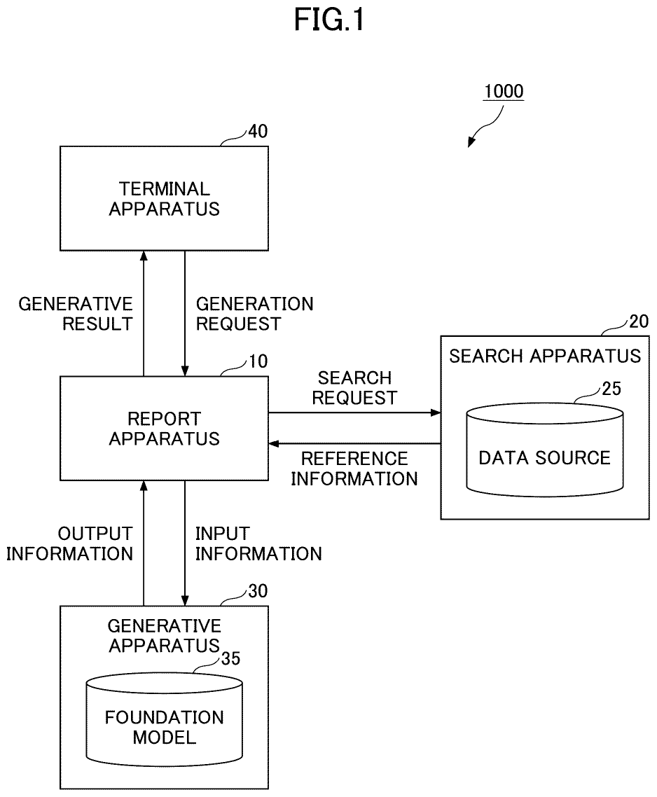

An overall configuration of the information processing system according to the present embodiment will be described with reference to FIG. 1. FIG. 1 is a block diagram illustrating an example of the overall configuration of the information processing system.

As illustrated in FIG. 1, an information processing system 1000 includes a report apparatus 10, a search apparatus 20, a generative apparatus 30, and a terminal apparatus 40. The report apparatus 10, the search apparatus 20, the generative apparatus 30, and the terminal apparatus 40 may be communicatively connected to one another via a communication network, such as a Local Area Network (LAN), the Internet, or the like.

The report apparatus 10 is an example of an information processing apparatus, such as a personal computer, a workstation, a server, or the like that instructs the generative apparatus 30 to execute a predetermined task according to a request from the terminal apparatus 40. In the present embodiment, the predetermined task may be a task for generating a report as an example of the output information.

The report apparatus 10 may acquire the search result for the reference information from the search apparatus 20, based on a generation request received from the terminal apparatus 40. The report apparatus 10 may transmit a search request to the search apparatus 20, based on the generation request.

The generation request is information or a signal for requesting generation of a report. The generation request may include information related to the output format, input information input by the user, and a search condition set by the user. Hereinafter, the information related to the output format is also referred to as “output format information”, and the input information input by the user is also referred to as “user input information”. At least a portion of the “output format information” may be information input by the user.

The search request is information or a signal requesting a search for the reference information. The search request may include a query and a search condition, for example. The query may include the user input information included in the generation request. The search condition may include the search condition included in the generation request.

The report apparatus 10 may generate input information to a foundation model 35, based on the search result for the reference information acquired from the search apparatus 20. The report apparatus 10 may transmit the search result for the reference information to the terminal apparatus 40, and generate the input information to the foundation model 35, based on the reference information selected by the terminal apparatus 40.

The report apparatus 10 may acquire, from the generative apparatus 30, output information that is generated by inputting the input information to the foundation model 35 to the foundation model 35. The report apparatus 10 may generate a report based on the output information, and transmit the report to the terminal apparatus 40 as a generative result with respect to the generation request.

The search apparatus 20 is an example of an information processing apparatus, such as a personal computer, a workstation, a server, or the like that searches for the reference information, according to a request from the report apparatus 10. The search apparatus 20 may include a data source 25 that stores various reference information. The data source 25 may be a storage device or a database in which reference information is stored, for example. The data source 25 may be provided in an external apparatus or system. The term “external” means not included in the information processing system 1000.

The search apparatus 20 may be implemented by a plurality of apparatuses or systems including different data sources 25. The search apparatus 20 may be implemented by a single apparatus or system including a plurality of data sources 25. The search apparatus 20 may be an external apparatus or system. The search apparatus 20 may search for the reference information in an external data source 25.

The generative apparatus 30 is an example of an information processing apparatus, such as a personal computer, a workstation, a server, or the like, which executes a predetermined task using the foundation model 35, according to a request from the report apparatus 10. The generative apparatus 30 may include the foundation model 35. The foundation model 35 is a machine learning model for executing the predetermined task. The foundation model 35 may be an LLM, for example.

The foundation model 35 may be implemented by a single foundation model. The foundation model 35 may be implemented by a plurality of foundation models cooperating with one another. The foundation model 35 may be configured by a plurality of foundation models according to the tasks to be executed.

The generative apparatus 30 may be implemented by a plurality of apparatuses or systems including different foundation models 35. The generative apparatus 30 may be implemented by a single apparatus or system including a plurality of foundation models 35. The generative apparatus 30 may be an external apparatus or system. The generative apparatus 30 may execute a predetermined task, based on an external foundation model 35.

The terminal apparatus 40 is an example of an information processing terminal, such as a personal computer, a smartphone, a tablet terminal, or the like operated by a user of the information processing system 1000. The terminal apparatus 40 may request the report apparatus 10 to execute a predetermined task. The terminal apparatus 40 may transmit a generation request including the output format information and the user input information to the report apparatus 10. The terminal apparatus 40 may receive the generative result from the report apparatus 10, and present the generative result to the user.

The terminal apparatus 40 may display the generative result on a display device of the terminal apparatus 40, for example. The terminal apparatus 40 may output audio synthesized from the generative result, from a speaker of the terminal apparatus 40, for example.

The overall configuration of the information processing system 1000 illustrated in FIG. 1 is merely an example, and various configuration examples of the information processing system may be employed according to the use or purpose. The information processing system 1000 may be configured by one or more apparatuses. The apparatuses included in the information processing system 1000 may configure a system composed of a plurality of apparatuses. Each function included in the information processing system 1000 may be implemented by an arbitrary apparatus included in the system. Each constituent element or component included in the information processing system 1000 may be included in an arbitrary apparatus configuring the system.

The data source 25 may be built in the report apparatus 10 or built in the generative apparatus 30. The data source 25 may be distributed and held in an external information processing system including a plurality of apparatuses. In this case, the search apparatus 20 may be omitted in the information processing system 1000.

The foundation model 35 may be built in the report apparatus 10 or built in the search apparatus 20. The foundation model 35 may be distributed and held in an external information processing system including a plurality of apparatuses. In this case, the generative apparatus 30 may be omitted in the information processing system 1000.

At least one of the report apparatus 10, the search apparatus 20, the generative apparatus 30, and the terminal apparatus 40 included in the information processing system 1000 may be configured by a plurality of apparatuses. In a case where the report apparatus 10 included in the information processing system 1000 is configured by a plurality of apparatuses, for example, the information processing system 1000 includes a plurality of report apparatuses 10. The report apparatus 10, the search apparatus 20, or the generative apparatus 30 may be implemented by a plurality of computers, or may be implemented as a cloud computing service. Two or more of the report apparatus 10, the search apparatus 20, and the generative apparatus 30 may be implemented by a standalone computer. A classification of the apparatuses, such as the report apparatus 10, the search apparatus 20, the generative apparatus 30, and the terminal apparatus 40 illustrated in FIG. 1 is merely an example.

For example, the information processing system 1000 may be configured by a server apparatus and one or more terminal apparatuses 40. The server apparatus may include the functions of the report apparatus 10, the search apparatus 20, and the generative apparatus 30. The server apparatus may be implemented by a system including a plurality of information processing apparatuses. The server apparatus may be implemented as a cloud computing service.

For example, the information processing system 1000 may be configured by a first server apparatus, a second server apparatus, and one or more terminal apparatuses 40. The first server apparatus may include the functions of the report apparatus 10 and the generative apparatus 30. The second server apparatus may include the functions of the search apparatus 20. Each of the first server apparatus and the second server apparatus may be implemented by a system including a plurality of information processing apparatuses. Each of the first server apparatus and the second server apparatus may be implemented as a cloud computing service.

For example, the information processing system 1000 may be configured by one or more information processing apparatuses. The one or more information processing apparatuses configuring the information processing system 1000 may include the functions of the report apparatus 10, the search apparatus 20, the generative apparatus 30, and the terminal apparatus 40. As another example, the information processing system may be configured by one or more information processing apparatuses including the functions of the report apparatus 10, the search apparatus 20, and the generative apparatus 30. In addition, the information processing system may be configured by one or more information processing apparatuses having the functions of the report apparatus 10 and the generative apparatus 30. Moreover, the information processing system may be configured by one or more information processing apparatuses including the functions of the report apparatus 10 and the generative apparatus 30. Further, the information processing system may be configured by one or more information processing apparatuses including at least a part of the functions of the report apparatus 10, the search apparatus 20, the generative apparatus 30, and the terminal apparatus 40.

### Functional Configuration of Report Apparatus

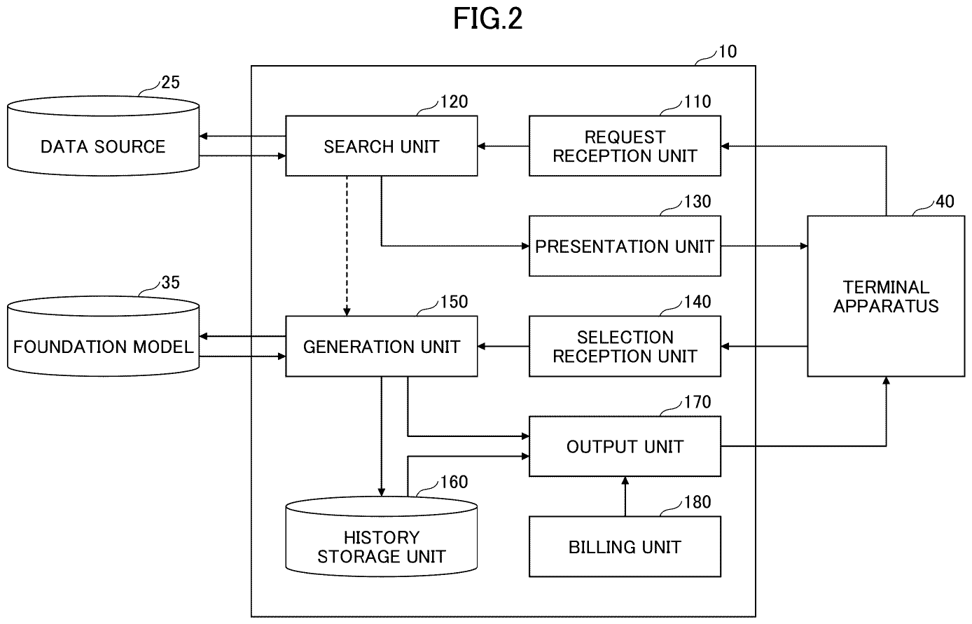

A functional configuration of the report apparatus 10 will be described with reference to FIG. 2. FIG. 2 is a block diagram illustrating an example of the functional configuration of the report apparatus.

As illustrated in FIG. 2, the report apparatus 10 includes a request reception unit 110, a search unit 120, a presentation unit 130, a selection reception unit 140, a generation unit 150, a history storage unit 160, an output unit 170, and a billing unit 180. The report apparatus 10 functions as a request reception unit 110, a search unit 120, a presentation unit 130, a selection reception unit 140, a generation unit 150, a history storage unit 160, an output unit 170, and a billing unit 180 by executing a program installed in advance.

The request reception unit 110 receives a generation request to generate a report. The request reception unit 110 may receive the generation request from the terminal apparatus 40. The generation request may be transmitted from the terminal apparatus 40 according to an operation with respect to a screen displayed on the display device of the terminal apparatus 40. The request reception unit 110 may receive a generation request input to the report apparatus 10. The generation request may be input to the report apparatus 10 according to the operation with respect to the screen displayed on the display device of the report apparatus 10.

The generation request may include the output format information and the user input information. The output format information may include information for designating or specifying the output format. The output format information may include information related to one or more output formats selected from a plurality of output formats. The output format information may be information capable of specifying the output format. The information capable of specifying the output format may be identification information for identifying the output format, or information indicating a location of a file in which the output format is described, for example.

The output format information may include information related to a structure of the report. The information related to the structure of the report may be information indicating the structure of one or more items included in the report. The information indicating the structure may include information related to at least one of an item name, an order of items, or a hierarchy of items, for example. The structure of the report may include at least one of a title, a subtitle, or a table of contents of the report, for example. The table of contents may include one or more headings.

The output format information may be information for designating or specifying a format of the output information. The format of the output information may include a natural language sentence, a markdown syntax, a Hyper Text Markup Language (HTML), an Extensible Markup Language (XML), a JavaScript (registered trademark) Object Notation (JSON) format, a Comma Separated Values (CSV) format, a Mermaid format, or the like, for example.

The output format information may be information indicating a file format. The information indicating the file format may be an extension of a file, for example. The file format may include text, image data, video data, acoustic data, a tabular format, a presentation format, or a Portable Document Format (PDF), for example.

The output format information may be selected from a plurality of pieces of output format information created in advance. The output format information may be newly created according to an operation performed by the user. The output format information may be selected or generated, according to an operation with respect to the screen displayed on the display device of the terminal apparatus 40. The output format information may be described using a tool, such as a text editor or the like, for example. The output format information created in advance may include a report generated in the past.

The output format information may be a research report format, for example. The research report format may include items, such as abstract, experimental procedure, results (discussion), summary (conclusion), or the like, for example.

The user input information may include a search term to be included in the query. The user input information may include a title of the report and the headings included in the table of contents, for example. The user input information may include one or more natural language sentences describing the contents of the entire report or the contents of each item included in the report, for example.

The user input information may include text data, structured data, image data, or acoustic data. The image data may be a still image or video, for example. The text data may be text data obtained by performing a speech recognition on the acoustic data or the video. The text data may be text obtained by performing a character recognition on the image data. The acoustic data may be audio data obtained by performing a speech synthesis on the text data. The structured data may be a table or a graph, for example.

The generation request may include a search condition for the reference information. The search condition may include at least one of information indicating the data source to be searched, a type of the data source, a time range of a creation date, attribute information of the reference information to be searched, a number of searched data to be included in the search result, or a condition of use, for example.

The information indicating the data source may be information capable of specifying the data source. The information capable of specifying the data source may be identification information for identifying the data source or information indicating the location of the data source (for example, a host name, an Internet Protocol (IP) address, a connection string, a Uniform Resource Locator (URL), or the like), for example.

The information indicating the data source may be set with respect to the entire report. The information indicating the data source may be set with respect to each item included in the report. The information indicating the data source may include a plurality of data sources. The information indicating the data source may include the data source of the entire report, and the data source for each item included in the report. In the case where the information indicating the data source includes a plurality of data sources, the information indicating the data source may include information indicating a priority of each data source.

The type of data source may include information indicating the inside or outside an organization, for example. The type of data source inside the organization may include at least one of the entire organization, a division of the organization (for example, a department or the like of a company), or a business database (for example, product information, sales information, or the like), for example. The type of the data source outside the organization may include at least one of a website (for example, a news website, a dictionary website, or the like), a search engine, or a Social Networking Service (SNS), for example.

The attribute information of the reference information to be searched may include at least one of information indicating a file format, a creation date, or a condition of use. The information indicating the file format may be an extension of the file, for example. The condition of use may include billing information related to the use of the reference information. The billing information may be information indicating whether or not to search for paid reference information.

The generation request may include user information related to the user. The user information may include at least one of an authority, an attribute, an affiliation, a job title or position, or a subscription plan of the user, for example. The authority of the user may include information indicating whether the user is executive management, for example. The subscription plan may include information indicating whether or not paid reference information is accessible, for example.

The search unit 120 searches for the reference information, based on the generation request received by the request reception unit 110. The search unit 120 may transmit a search request including the user input information included in the generation request to the search apparatus 20, for example. The search unit 120 may receive a search result transmitted by the search apparatus 20 according to the search request. The search result may include a plurality of pieces of reference information satisfying the search condition indicated in the search request.

The search request may include at least one of a query or a search condition. The query may be generated based on the user input information included in the generation request. For example, the query may include a keyword included in the user input information. The search condition may include the search condition included in the generation request. The search condition may include a predetermined search condition. The search unit 120 may set the search condition, based on the user information included in the generation request.

The search unit 120 may search for the reference information from a plurality of data sources indicated in the search condition. The search unit 120 may control the data source to be searched, based on the user information included in the generation request. For example, in a case where the authority or the subscription plan of the user indicates that paid reference information is not accessible, the search unit 120 may exclude the data source storing the paid reference information from a search target.

The search unit 120 may include the reference information for the number of items indicated in the search condition, in the search result. The search unit 120 may include the reference information for a predetermined number of items, in the search result. The search unit 120 may set the number of items of the reference information to be included in the search result, based on the authority or the subscription plan of the user. The search unit 120 may set the number of items of the reference information to be included in the search result, according to an amount of data that can be input to the foundation model 35.

The presentation unit 130 presents information related to the search result for the reference information searched by the search unit 120, to the user. The information related to the search result may include at least one of a data source of the reference information, link information, at least a portion of the reference information, a summary, a thumbnail image (or a reduced image), an owner, a copyright holder, a creation date, or a condition of use, for example. The condition of use may include information indicating whether the use of the reference information is paid service or not. The information indicating whether the reference information is paid service or not may include information indicating whether the reference information is paid or free, a usage fee, or a consumption point. The usage fee and the consumption point may be numerical values, or may be 0 in a case where the reference information is free.

The presentation unit 130 may transmit the search result for the reference information to the terminal apparatus 40, and cause the display device of the terminal apparatus 40 to display the search result for the reference information. The presentation unit 130 may display the search result for the reference information on the display device of the report apparatus 10. Presenting information to the user may include a processor performing at least a portion of processes required to display the information on the display device. The display device may be provided in the same apparatus that includes the processor, or may be provided in an apparatus different from the apparatus that includes the processor. The display device may include a plurality of display devices.

The presentation unit 130 presents the search result for the reference information in a manner selectable by the user. The presentation unit 130 may control the selectable reference information, based on the user information. For example, in a case where the user information indicates that paid reference information is not accessible, the presentation unit 130 may present the paid reference information to the user in a non-selectable manner.

The presentation unit 130 may present information related to the search result (hereinafter also referred to as auxiliary information of the reference information), together with the search result for the reference information. The auxiliary information of the reference information may include at least one of a data source, link information, a portion of the reference information, a summary, a thumbnail image, an owner, a copyright holder, a creation date, or a condition of use, for example. The auxiliary information of the reference information may present a combination of arbitrary two or more among the data source, the link information, the portion of information, the summary, the thumbnail image, the owner, the copyright holder, the creation date, and the condition of use. The presentation unit 130 may generate at least a portion of the auxiliary information of the reference information based on the foundation model 35 or another foundation model.

The data source is information indicating a data source in which the reference information was stored. The link information is information (for example, a URL or the like) indicating the location of the reference information. The portion of the reference information may include at least one of a title or a heading of the reference information, a predetermined number of characters or a predetermined number of lines from the beginning, or a keyword extracted from the reference information, for example. The summary or the thumbnail image may be acquired from the data source 25, or generated based on the foundation model 35 or other foundation model, for example.

The condition of use may include billing information. The billing information may include information indicating whether the reference information is accessible for a fee or is accessible for free. The condition of use may include copyright information. The copyright information may include terms of use. The terms of use may be set by the owner or the copyright holder of the reference information. In a case where the condition of use for the reference information indicates that the reference information is not accessible, the presentation unit 130 may present to the user a message prompting the user to enter a contract with the owner or the copyright holder of the reference information.

The selection reception unit 140 receives a selection request for the reference information. The selection reception unit 140 may receive the selection request from the terminal apparatus 40. The selection request may be transmitted from the terminal apparatus 40, according to an operation with respect to a screen displayed on the display device of the terminal apparatus 40. The selection reception unit 140 may receive a selection request input to the report apparatus 10. The selection request may be input to the report apparatus 10, according to an operation with respect to a screen displayed on the display device of the report apparatus 10.

The selection request is information or a signal for requesting the selection of one or more pieces of reference information to be used for the generation of the output information. The selection request may be information indicating one or more pieces of reference information selected by the user, from the search result for the reference information presented by the presentation unit 130.

The selection reception unit 140 acquires the reference information indicated in the selection request. The selection reception unit 140 may acquire information capable of identifying the reference information. The information capable of identifying the reference information may be identification information for identifying the reference information, or information indicating the location of a file in which the reference information is described, for example.

The selection request may include one or more pieces of reference information specified by the user. The reference information specified by the user may be reference information that is not included in the search result for the reference information. The reference information specified by the user may be information indicating the location of the reference information (for example, a URL or the like), for example.

The generation unit 150 acquires the output information from the foundation model 35, based on the generation request received by the request reception unit 110 and the one or more pieces of reference information acquired by the selection reception unit 140. The generation unit 150 may generate input information to the foundation model 35, based on the generation request and the reference information, and transmit the input information to the generative apparatus 30, for example. Hereinafter, the input information to the foundation model 35 is also referred to as “model input information”.

The generation unit 150 may acquire the output format information and the user input information from the generation request, and generate the model input information by embedding the output format information, the user input information, and the reference information into a predetermined template. The generation unit 150 may generate the model input information by processing the template, the output format information, the user input information, and the reference information based on a predetermined rule. The generation unit 150 may generate the model input information by inputting the template, the output format information, the user input information, and the reference information to another foundation model. The generation unit 150 may receive output information generated from the generative apparatus 30 when the generative apparatus 30 inputs the model input information to the foundation model 35.

The generation unit 150 may generate the model input information, based on one or more pieces of reference information searched by the search unit 120, one or more pieces of reference information selected by the user, or one or more pieces of reference information specified by the user. The generation unit 150 may generate the model input information, based on an arbitrary combination of the one or more pieces of reference information searched by the search unit 120, the one or more pieces of reference information selected by the user, and the one or more pieces of reference information specified by the user. The generation unit 150 may generate the model input information using at least a portion of information included in each reference information. In addition, the generation unit 150 may generate the model input information using information obtained by processing each reference information. Moreover, the generation unit 150 may generate the model input information using at least a portion of information included in the output format information, or may generate the model input information using information obtained by processing the output format information. Further, the generation unit 150 may generate the model input information using at least a portion of information included in the user input information, or may generate the model input information using information obtained by processing the user input information.

The generation unit 150 may cause one foundation model 35 selected from a plurality of foundation models 35 to generate the output information, by inputting the model input information to the selected one foundation model 35. The foundation model 35 used for generating the output information may be specified by the generation request, for example. The foundation model to be specified by the generation request may be selected by the user. The foundation model 35 used for generating the output information may be selected based on the authority or the subscription plan of the user, for example.

The template for generating the model input information may include one or more placeholders for embedding the output format information, the user input information, or the reference information. The template may include instruction information for instructing generation of a report. The template may include information specifying an output format. The template may include constraint information related to the output information. The instruction information and the constraint information may be predetermined fixed sentences.

The model input information may include text data, image data, or acoustic data. The text data may be a natural language sentence called a prompt, for example. The image data may be a still image or a video, for example. The text data may be text data obtained by performing a speech recognition on the acoustic data or the video. The text data may be text obtained by performing a character recognition on the image data. The image data may include an image captured by the user, for example. The acoustic data may include speech uttered by the user. The acoustic data may be audio data obtained by performing a speech synthesis on the text data.

The history storage unit 160 stores history information of the output information generated by the generation unit 150. The history storage unit 160 may accumulate the output information in time series. The history storage unit 160 may store information used for generating the output information. The information used for the generation may include at least one of the data source to be searched (or the data source that is the search target), the foundation model used for the generation, the user input information, the output format information, the reference information used for the generation, or the model input information, for example.

The history storage unit 160 may store the output information and the information used for the generating the output information in association with each other. In an example of a method of associating the output information with the information used for the generation thereof, the output information and the information used for the generation thereof may be stored as one set, information that enables one information to acquire the other information may be stored, or identification information of one information and identification information of the other information may be stored as one set.

The output unit 170 outputs a generative result with respect to the generation request received by the request reception unit 110, based on the output information acquired by the generation unit 150. The output unit 170 may transmit the generative result including the output information to the terminal apparatus 40. The output unit 170 may display the generative result including the output information on the display device of the report apparatus 10.

The output unit 170 may generate a report based on the output information, and output a generative result including the report. The output unit 170 may generate the output information itself as a report. The output unit 170 may generate a report including a portion of the output information. The output unit 170 may generate a report by processing the output information.

The output unit 170 may include auxiliary information of the reference information used for generating the output information, in the report. The auxiliary information of the reference information may be the same as the auxiliary information displayed by the presentation unit 130 together with the search result for the reference information.

The output unit 170 may output the report in a predetermined file format that is savable. The output unit 170 may output the report in an editable format. The output unit 170 may output the edited report in the predetermined file format that is savable. The file format may be selectable by the user. For example, the output unit 170 may output the output information described in a markdown syntax in an editable format. The output unit 170 may output the markdown syntax with extensibility.

The output unit 170 may set a range of use of the report. The range use may include at least one of a number of duplications or an extent of disclosure, for example. The output unit 170 may determine the range of use of the report, based on the condition of use for the reference information used to generate the report.

The output unit 170 may display a plurality of reports for comparison. The output unit 170 may display a plurality of reports side by side and above and below each other. The plurality of reports may include the output information acquired by the generation unit 150 and the output information stored in the history storage unit 160, respectively. The plurality of reports may include a plurality of pieces of output information acquired by the generation unit 150 at different timings.

The plurality of reports may be a plurality of reports generated based on different information. The plurality of reports may be a plurality of reports using different foundation models for generating the output information, for example. The plurality of reports may be a plurality of reports of different data sources to be searched, for example. The plurality of reports may be a plurality of reports having different user input information, for example. The plurality of reports may be a plurality of reports in which two or more of the foundation model, the data source, and the user input information are different, for example.

The output unit 170 may output difference information of a plurality of reports displayed for comparison. The output unit 170 may highlight the differences among the plurality of reports. The highlighted display may vary at least one of a character type, a character color, a background color, or a character size, for example.

The billing unit 180 bills the user for the cost related to the generation of the report. The cost may be in currency or points. The billing in currency may be settled each time, or may be settled at a predetermined time intervals (for example, monthly or the like). The billing by points may consume points purchased by the user in advance or points given to the user in advance, for example.

The billing unit 180 may bill the user for the cost related to the generation of the report, in a case where the search unit 120 searches the data source storing paid reference information, or in a case where the selection reception unit 140 receives the selection of paid reference information. The billing unit 180 may determine the cost to be billed to the user, based on at least one of a volume or a number of reference information used for generating the report. The billing unit 180 may control the search unit 120, the selection reception unit 140, or the generation unit 150 so as not to use the reference information for a number of items exceeding the number of items determined by the subscription plan of the user.

The billing unit 180 may bill the user for the cost related to the use of the report. The billing unit 180 may determine the cost required to generate or use the report, based on the condition of use for each piece of reference information used for generating the report. The use of the report may include making the report available for review by the user, downloading the report, or duplicating the report. for example. The billing unit 180 may bill the user for the cost related to the use of the report, in a case where the user displays the report, or in a case where the user saves the report. The billing unit 180 may determine the cost to be billed to the user, based on at least one of a number of times the report is displayed or a number of times the report is saved.

The billing unit 180 may present additional information related to the generation of the report or the use of the report, to the user. The additional information may include at least one of a time, a cost, or a computing resource required to generate or use the report.

The billing unit 180 may present the additional information related to the generation of the report to the user, before outputting the report. The billing unit 180 may present the cost required to generate the report to the user, before outputting the report. For example, the billing unit 180 may present the additional information including the cost to the user, before the search unit 120 searches for the data source storing the paid reference information, or before the generation unit 150 generates the model input information using the paid reference information.

In a case where the billing unit 180 acquires a generation instruction from the user after presenting the additional information related to the generation of the report to the user, the billing unit 180 may notify the generation unit 150 of the acquisition of the generation instruction. When the generation unit 150 is notified of the acquisition of the generation instruction from the billing unit 180, the generation unit 150 may generate the model input information and transmit the model input information to the generative apparatus 30. By presenting the cost to the user before generating the report, the user can confirm the cost required to generate the report before generating the report, and thereafter instruct execution of a report generation process. In a case where the cost is higher than anticipated by the user, the user can stop the report generation process.

The billing unit 180 may present additional information related to the use of the report to the user, after the report is output. The billing unit 180 may present the user with the additional information including the cost, before the user displays the report, or before the user saves the report, for example.

The functional configuration of the report apparatus 10 illustrated in FIG. 2 is merely an example, and various configuration examples of the report apparatus may be employed according to the use or purpose. The presentation unit 130 and the selection reception unit 140 may be omitted in the report apparatus 10. In this case, the generation unit 150 may generate the model input information, based on the search result for the reference information searched by the search unit 120. For example, the generation unit 150 may generate the model input information by inputting all the reference information or a predetermined number of reference information included in the search result into the template.

One user or multiple users may operate the terminal apparatus 40. For example, the user who inputs the output format information and the user input information, the user who selects the reference information, and the user who refers to the generative result may be the same user or may be different users. The terminal apparatus for performing the operation to input the output format information and the user input information, the terminal apparatus for performing the operation to select the reference information, and the terminal apparatus for displaying the generative result may be the same terminal apparatus or may be different terminal apparatuses.

### Template of Prompt

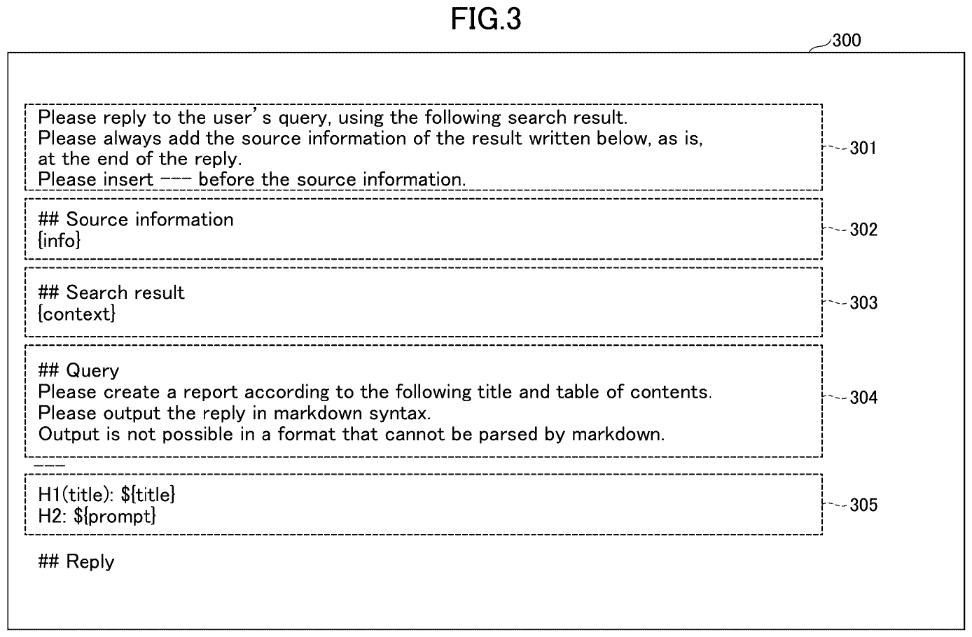

A template for generating a prompt, which is an example of the model input information, will be described with reference to FIG. 3. FIG. 3 is a diagram illustrating an example of the template.

As illustrated in FIG. 3, a template 300 includes instruction information 301, source information 302, a search result 303, instruction information 304, and an output format 305. The instruction information 301 and 304 includes information instructing generation of a report, and constraint information related to the generation of a report. The instruction information 301 and 304 may be a predetermined fixed sentence.

The source information 302 includes a placeholder {info}. Information related to the data source that stores the reference information used to generate the output information is embedded into the placeholder {info}. The search result 303 includes a placeholder {context}. Reference information used to generate output information is embedded into the placeholder {context}.

The output format 305 includes output format information. The output format 305 includes placeholders {title} and {prompt}. The placeholder {title} is embedded with the user input information input to a title of the report. The placeholder {prompt} is embedded with the user input information input to a heading of the report.

The template 300 includes one placeholder {context} for embedding the reference information, but the template 300 may include a plurality of placeholders for embedding the reference information. The plurality of pieces of reference information may be embedded into the plurality of placeholders, respectively. At least a portion of the information included in the reference information may be embedded into each placeholder, or information obtained by processing the reference information may be embedded into each placeholder.

The generation unit 150 can generate the model input information, by embedding the required information into the placeholder of the template. The generation unit 150 may generate the model input information without using the template. However, the generation unit 150 can easily generate the model input information, by using the template. The template may be optimized in advance so that good output information is obtainable. By generating a prompt using the optimized template, it is possible to stably acquire good output information from the foundation model 35.

### User Interface

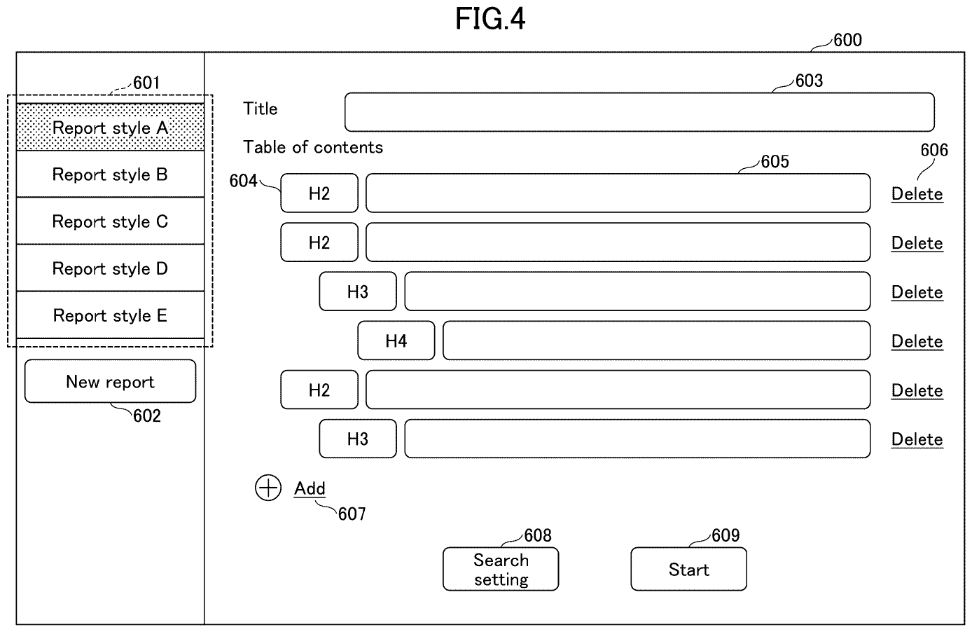

A user interface provided by the report apparatus 10 will be described with reference to FIG. 4 through FIG. 7. The user interface of the report apparatus 10 is displayed on the display device of the report apparatus 10 or the terminal apparatus 40, for example. In the present embodiment, an example in which each screen is displayed on the display device of the terminal apparatus 40 will be described.

The user interface of the report apparatus 10 may include a format specifying screen, a condition setting screen, a selection screen, and a display screen, for example. The format specifying screen is a screen for specifying the output format of the report. The condition setting screen is a screen for setting the search condition for the reference information. The selection screen is a screen for selecting the reference information to be used for generating the report. The display screen is a screen for displaying the report.

### Format Specifying Screen

FIG. 4 is a diagram illustrating a first example of the format specifying screen. The first example of the format specifying screen is an example of the format specifying screen for specifying the structure of the report.

As illustrated in FIG. 4, a format specifying screen 600 includes a style selection part 601, a new creation button 602, a title input part 603, a hierarchy selection part 604, a heading input part 605, a delete link 606, an add link 607, a setting button 608, and a start button 609.

A list of created report styles is displayed in the style selection part 601. The report style is an example of the output format information. The report style is information that defines the structure of the report. The structure of the report includes a title and a table of contents. When the user selects the report style in the style selection part 601, the title and the table of contents defined in the report style are displayed on the format specifying screen 600.

The new creation button 602 is a button for newly creating a report style. When the user presses the new creation button 602, the title and the table of contents displayed on the format specifying screen 600 are initialized, and input to the title and the table of contents is enabled.

The title input part 603 is an input field for inputting the title of the report. The title input part 603 may receive an input of the title of the report from the user. The title input part 603 may initially display the title set in the report style selected by the style selection part 601. The title input part 603 may receive editing of the initially displayed title. The title initially displayed in the title input part 603, or the title edited by the user, is embedded into the placeholder {title} of the template 300 illustrated in FIG. 3.

The hierarchy selection part 604 is a selection field for selecting a hierarchy of each item included in the table of contents. H2, H3, and H4 displayed in the hierarchy selection part 604 are symbols indicating the hierarchy of the heading. The hierarchy selection part 604 may be added or deleted according to an operation by the user.

The heading input part 605 is an input field for inputting the heading of each item included in the table of contents. The heading input part 605 may receive an input of the heading of an item from the user. The heading input part 605 may initially display the heading set in the report style selected by the style selection part 601. The heading input part 605 may receive editing of the initially displayed heading. The heading initially displayed in the heading input part 605, or the heading edited by the user, is embedded into the placeholder {prompt} of the template 300 illustrated in FIG. 3.

The delete link 606 is an operation part for deleting the heading input part 605. When the user operates the delete link 606, the hierarchy selection part 604 and the heading input part 605 corresponding to the delete link 606 are deleted from the format specifying screen 600.

The add link 607 is an operation part for adding the heading input part 605. When the user operates the add link 607, a new hierarchy selection part 604 and a new heading input part 605 are added to the format specifying screen 600.

The setting button 608 is a button for setting the search condition. When the user presses the setting button 608, the condition setting screen is activated.

The start button 609 is a button for starting the generation of the report. When the user presses the start button 609, the generation request is transmitted to the report apparatus 10 based on the information input to the format specifying screen 600.

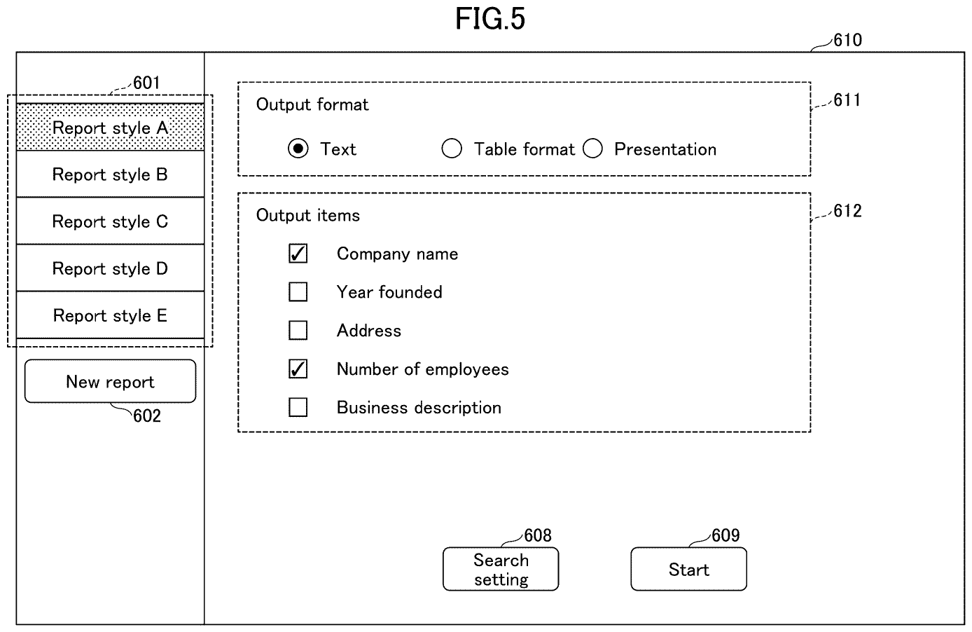

FIG. 5 is a diagram illustrating a second example of the format specifying screen. The second example of the format specifying screen is an example of the format specifying screen for specifying a file format of the report.

As illustrated in FIG. 5, the format specifying screen 610 includes a style selection part 601, a new creation button 602, a file format selection part 611, an output item selection part 612, a setting button 608, and a start button 609.

The file format selection part 611 displays options of the file format of the report in a selectable manner. The options of the file format may be determined in advance. A template file created in advance in each file format may be set in the options of the file format. The structure of the report may be described in the template file. For example, the title and the heading may be described in the template file.

The output item selection part 612 displays options of output items of the report in a selectable manner. The options of the output items may be determined in advance, or may be read from the template file. The output item selected by the user in the output item selection part 612 may be included in the output format information as the table of contents of the report, for example.

### Condition Setting Screen

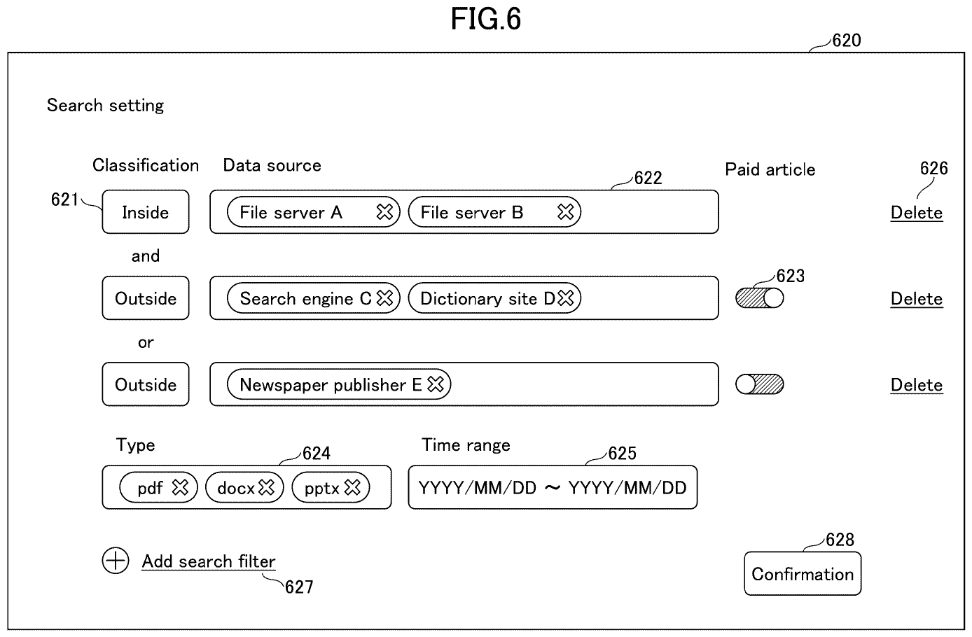

FIG. 6 is a diagram illustrating an example of the condition setting screen. As illustrated in FIG. 6, a condition setting screen 620 includes a category selection part 621, a data source input part 622, a paid setting part 623, a type input part 624, a time range input part 625, a delete link 626, an add link 627, and a confirm button 628.

The category selection part 621 displays options of the category of the data source in a selectable manner. The category options may include the inside of the organization and the outside of the organization, for example.

The data source input part 622 is an input field for inputting the data source. The data source input to the data source input part 622 is used to search for the reference information. When the user inputs the name of the data source into the data source input part 622, the name of the data source may be complemented with a predetermined name. The data source input part 622 is an input field for setting the data source of the entire report, but the data source input part 622 may be set with the data source for each item of the report.

The paid setting part 623 displays whether or not paid reference information is to be searched for each data source in a selectable manner. When the user selects to search for the paid reference information in the paid setting part 623, the reference information is searched from the data source regardless of whether or not the reference information is the paid reference information. On the other hand, when the user selects not to search for the paid reference information in the paid setting part 623, only the free reference information is searched from the data source. The paid setting part 623 is displayed for each data source. However, the paid setting part 623 may be displayed only in a case where the data source is an external data source outside the organization, and in this case, the paid setting part 623 is not displayed only for the other data sources.

The type input part 624 is an input field for inputting the file format of the reference information. The type input part 624 may receive an input of an extension of the file. When the file format is input to the type input part 624, only the reference information having the input file format is searched.

The time range input part 625 is an input field for inputting a time range of the reference information. The time range input part 625 may receive an input of both or one of the start and end of the time range to be searched. When the time range is input to the time range input part 625, only the reference information having a creation date included in the time range is searched.

The delete link 626 is an operation part for deleting the data source input part 622. When the user operates the delete link 626, the category selection part 621 and the data source input part 622 corresponding to the delete link 626 are deleted from the condition setting screen 620.

The add link 627 is an operation part for adding the data source input part 622. When the user operates the add link 627, a new category selection part 621 and a new data source input part 622 are added to the condition setting screen 620.

The confirm button 628 is a button for confirming the setting of the search condition. When the user presses the confirm button 628, the search condition is set based on the information input to the condition setting screen 620. The set search condition is included in the generation request transmitted to the report apparatus 10.

In the condition setting screen 620, information that can be set in the category selection part 621, the data source input part 622, the type input part 624, and the time range input part 625 may be controlled based on the authority or the subscription plan of the user.

Although the condition setting screen 620 is activated by the operation with respect to the format specifying screen 600 or 610 in the example described above, the condition setting screen 620 may be activated at an arbitrary timing. For example, the condition setting screen 620 may be configured to be activated before the format specifying screen 600 or 610 is activated. In other words, the search condition may be set before the output format information and the user input information are input.

### Selection Screen

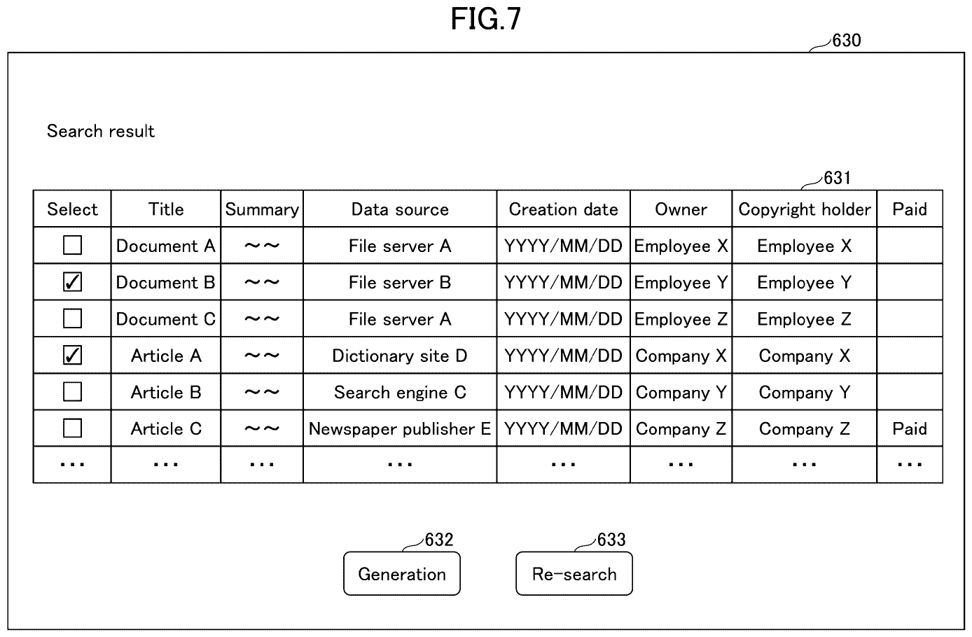

FIG. 7 is a diagram illustrating an example of the selection screen. When the terminal apparatus 40 receives the search result for the reference information from the report apparatus 10, a selection screen 630 is displayed on the display device of the terminal apparatus 40.

As illustrated in FIG. 7, the selection screen 630 includes a list display part 631, a generation button 632, and a re-search button 633.

The list display part 631 displays the search result for the reference information. The list display part 631 displays the reference information included in the search result in a selectable manner. The list display part 631 displays auxiliary information of the reference information, together with information indicating the reference information. The list display part 631 may display a title, a summary, a data source, a creation date, an owner, a copyright holder, and a condition of use (paid or free service) for each piece of reference information. The title is an example of information indicating the reference information. The summary, the data source, the creation date, the owner, the copyright holder, and the condition of use are examples of the auxiliary information. At least a portion of the auxiliary information of the reference information may be generated based on the foundation model 35 or based on another foundation model.

The list display part 631 may display link information of the reference information. The user may be able to confirm the entire text of the reference information by clicking the link information. The list display part 631 may display thumbnails of the reference information.

The list display part 631 may display information indicating whether or not each reference information is selected. The information indicating whether or not each reference information is selected may be at least one of a check box, a check mark, a background color, or a character color, for example. The background color or the character color may be displayed in a different color depending on whether or not each reference information is selected.

The list display part 631 may receive an input of new reference information. The new reference information may be specified by the user of the terminal apparatus 40 that displays the selection screen 630. The selection screen 630 may receive the input of the new reference information by a screen component different from the list display part 631. The new reference information may be input on a screen different from the selection screen 630, and the selection screen 630 may receive an operation for activating the screen. The list display part 631 may receive an input of the auxiliary information together with the new reference information. At least a portion of the auxiliary information of the new reference information may be generated based on the foundation model 35 or based on another foundation model.

The list display part 631 may include an add button for adding the new reference information. The user may add the new reference information by pressing the add button. The user may add the reference information by simply specifying the link information of the reference information. The list display part 631 may generate and display the title, the summary, or the like of the new reference information, based on the information at a link destination.

The user may add the new reference information by moving a file to a predetermined location by a drag-and-drop operation. In this case, information included in the file becomes the new reference information. The predetermined location that is a moving destination may be the list display part 631 or may be newly set in the selection screen 630. For example, the reference information may be added by moving the file into a frame of the list display part 631. A target of the drag-and-drop operation is not limited to the file, and may be an object that can generally be a target of the drag-and-drop operation, such as a text, an image, link information, or the like. Even in a case where the object other than the file is subjected to the drag-and-drop operation, information included in the object or information associated with the object becomes the new reference information. The user may add the new reference information by an operation of storing the file to be used as the reference information in a predetermined directory. The predetermined directory may be a directory specified by the user, or a directory assigned to each user by the information processing system.

The new reference information added by the user may be displayed in the list display part 631 in a mode distinguishable from other reference information. For example, information indicating that the reference information is the new reference information added by the user may be displayed in the “data source” field. A file name of the reference information added by the drag-and-drop operation of the file may be displayed in the “title” field.

The list display part 631 may display information for specifying the new reference information. The information for specifying the reference information may be information related to the drag-and-drop operation, or information related to the directory where the new reference information is to be stored, for example. The information related to the drag-and-drop operation may include information related to the destination of the drag-and-drop (or a frame itself of the destination), or a display (or a description) indicating that the information can be added by the drag-and-drop operation, for example. The information for specifying the reference information may be information for separately specifying the reference information included in the plurality of pieces of reference information by the drag-and-drop operation. That is, the information for specifying the reference information does not need to be information for specifying only the new reference information.

The generation button 632 is a button for instructing generation of output information. When the user presses the generation button 632, a selection request indicating the reference information selected in the list display part 631 is transmitted to the report apparatus 10.

The re-search button 633 is a button for searching for the reference information again. When the user presses the re-search button 633, the selection screen 630 is closed and the screen returns to the format specifying screen 600. In this state, the search result for the reference information displayed in the list display part 631 may be discarded or saved. In a case where the search result for the reference information is saved, two search results may be displayed for comparison on the selection screen 630 displayed after the re-search.

### Display Screen

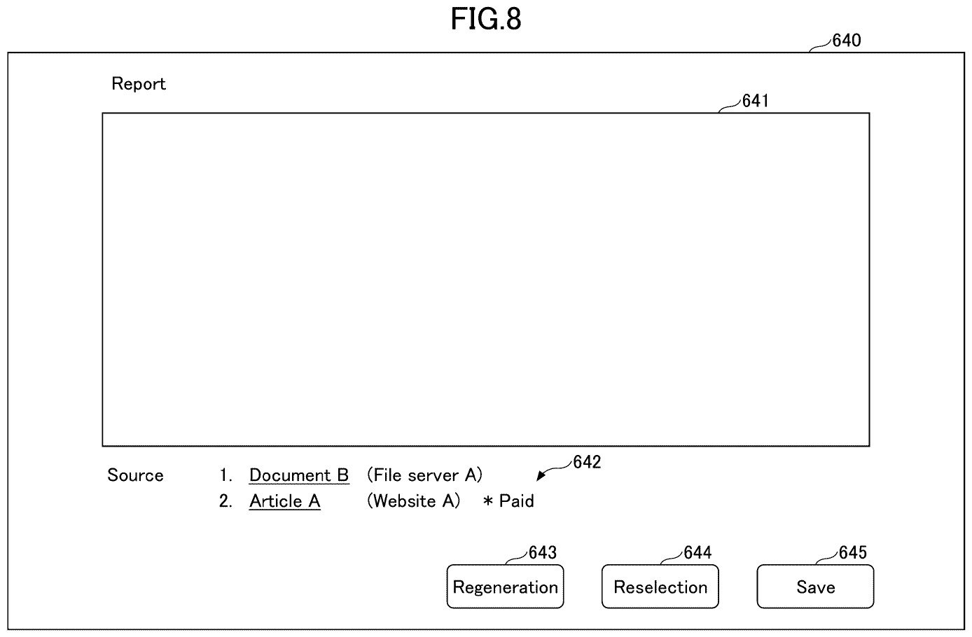

FIG. 8 is a diagram illustrating an example of the display screen. When the terminal apparatus 40 receives the generative result from the report apparatus 10, a display screen 640 is displayed on the display device of the terminal apparatus 40.

As illustrated in FIG. 8, the display screen 640 includes a report display part 641, a source display part 642, a regeneration button 643, a reselection button 644, and a save button 645.

The report display part 641 displays a report received from the report apparatus 10. The report display part 641 may display the report in an editable manner. The report display part 641 may have a function of a text editor, for example.

The source display part 642 displays source information of the reference information used for generating the report. The source information may include a link of the reference information, a data source that stores the reference information, and a condition of use (paid or free service) for the reference information, for example. The reference information may become accessible when the user clicks the link of the reference information.

The regeneration button 643 is a button for regenerating a report. When the user presses the regeneration button 643, the display screen 640 is closed and the screen returns to the format specifying screen 600. When the screen returns to the format specifying screen 600, the user can vary the output format or the user input information, and start generating a new report.

The reselection button 644 is a button for reselecting the reference information. When the user presses the reselection button 644, the display screen 640 is closed and the screen returns to the selection screen 630. When the screen returns to the selection screen 630, the user can vary the reference information to be selected, and start generating a new report.

The save button 645 is a button for saving a report. When the user presses the save button 645, the report displayed in the report display part 641 is stored in the storage device of the terminal apparatus 40. In a case where the user edits the report in the report display part 641, the edited report is saved. Whether or not the save button 645 can be pressed may be controlled according to the authority or the subscription plan of the user.

### Other Screens

The user interface of the report apparatus 10 may include a screen for selecting a foundation model to be used for generating a report from a plurality of foundation models. The user interface of the report apparatus 10 may include a screen for selecting a data source to be used to search for the reference information from a plurality of data sources. The user interface of the report apparatus 10 may include a screen for setting selectable data sources or foundation models.

The user interface of the report apparatus 10 may include a screen for confirming a cost billed to the user. The user interface of the report apparatus 10 may include a screen for settling the cost billed to the user.

### Flow Chart of Report Generation Process

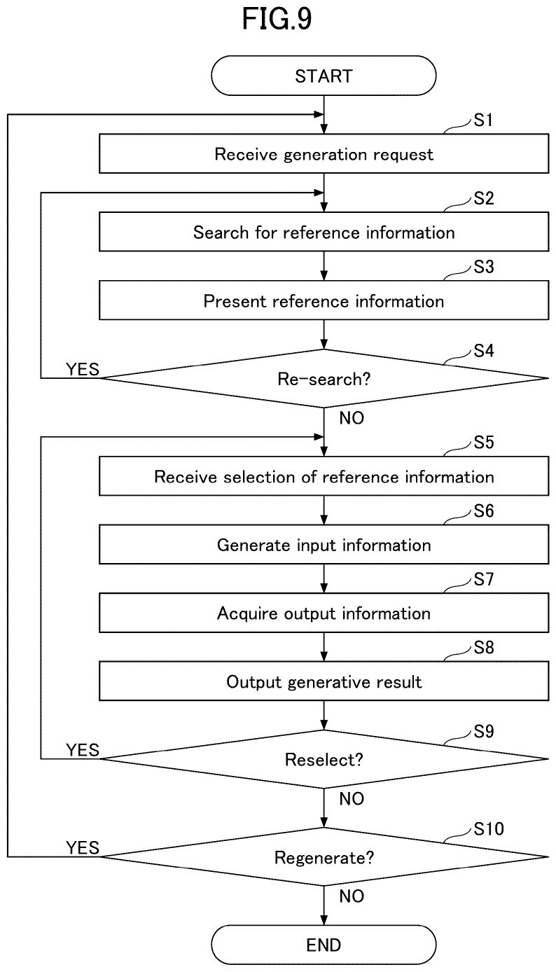

The report generation process performed by the information processing system 1000 will be described with reference to FIG. 9. FIG. 9 is a flow chart illustrating an example of the report generation process according to the first embodiment.

In step S1, the terminal apparatus 40 transmits a generation request to the report apparatus 10 according to a user operation with respect to the format specifying screen 600. The generation request includes the output format information and the user input information input to the format specifying screen 600. The generation request may include a search condition input to the condition setting screen 620.

The request reception unit 110 of the report apparatus 10 receives the generation request from the terminal apparatus 40. The request reception unit 110 accepts the received generation request. The request reception unit 110 sends the user input information and the search condition to the search unit 120. In addition, the request reception unit 110 sends the output format information and the user input information to the generation unit 150.

In step S2, the search unit 120 of the report apparatus 10 receives the user input information and the search condition from the request reception unit 110. The search unit 120 sends a search request to the search apparatus 20, based on the user input information and the search condition. The search request includes a query including the user input information and the search condition.

The search apparatus 20 receives the search request from the report apparatus 10. The search apparatus 20 searches for the reference information from the data source 25, based on the search request. The search apparatus 20 transmits the search result for the reference information to the report apparatus 10. The search apparatus 20 may search for the reference information by an arbitrary method based on the search request.

The search unit 120 of the report apparatus 10 receives the search result for the reference information from the search apparatus 20. The search unit 120 sends the search result for the reference information to the presentation unit 130.

In step S3, the presentation unit 130 of the report apparatus 10 receives the search result for the reference information from the search unit 120. The presentation unit 130 transmits the search result for the reference information to the terminal apparatus 40.

The terminal apparatus 40 receives the search result for the reference information from the report apparatus 10. The terminal apparatus 40 displays the selection screen 630 on the display device. The search result for the reference information is displayed on the selection screen 630.

In step S4, the terminal apparatus 40 determines whether or not to re-search for the reference information. Specifically, in a case where the re-search button 633 of the selection screen 630 is pressed, the terminal apparatus 40 determines that the re-search for the reference information is to be performed. On the other hand, in a case where the generation button 632 of the selection screen 630 is pressed, the terminal apparatus 40 determines that the re-search for the reference information is not to be performed.

In the case where the reference information is to be re-searched (YES), the terminal apparatus 40 requests the report apparatus 10 to perform the re-search. The report apparatus 10 returns the process to step S2 according to the request from the terminal apparatus 40. On the other hand, in the case where re-search for the reference information is not to be performed (NO), the terminal apparatus 40 transmits a selection request to the report apparatus 10. The selection request includes information indicating the reference information selected on the selection screen 630.

In step S5, the selection reception unit 140 of the report apparatus 10 receives the selection request from the terminal apparatus 40. The selection reception unit 140 accepts the received selection request. The selection reception unit 140 acquires the reference information indicated in the selection request. The selection reception unit 140 sends the acquired reference information to the generation unit 150. In addition, the selection reception unit 140 may transmit the new reference information added by the user to the generation unit 150.

The processes from step S3 to step S5 may be omitted. In this case, in step S2, the search unit 120 may send the search result for the reference information received from the search apparatus 20 to the generation unit 150. Further, the selection reception unit 140 may transmit the new reference information added by the user to the generation unit 150.

In step S6, the generation unit 150 of the report apparatus 10 receives the reference information from the selection reception unit 140. In addition, the generation unit 150 receives the output format information and the user input information from the request reception unit 110.

The generation unit 150 generates model input information, based on the output format information, the user input information, and the reference information. The generation unit 150 may generate the model input information, by embedding the output format information, the user input information, and the reference information into a predetermined template. The generation unit 150 transmits the model input information to the generative apparatus 30.

In step S7, the generative apparatus 30 receives the model input information from the report apparatus 10. The generative apparatus 30 inputs the received model input information to the foundation model 35. The foundation model 35 executes a predetermined task based on the model input information, and outputs output information generated as a result. The generative apparatus 30 transmits the output information output from the foundation model 35 to the report apparatus 10.

The generation unit 150 of the report apparatus 10 receives the output information from the generative apparatus 30. The generation unit 150 stores the received output information in the history storage unit 160 in association with the information used for generating the output information. In addition, the generation unit 150 sends the output information to the output unit 170.

In step S8, the output unit 170 of the report apparatus 10 receives the output information from the generation unit 150. The output unit 170 generates a report based on the output information. The output unit 170 transmits a generative result including the generated report to the terminal apparatus 40. The report may include auxiliary information of the reference information.

The terminal apparatus 40 receives the generative result from the report apparatus 10. The terminal apparatus 40 displays the display screen 640 on the display device. The display screen 640 displays a report included in the generative result. The display screen 640 may display the auxiliary information included in the report.

In step S9, the terminal apparatus 40 determines whether or not to reselect the reference information. Specifically, in a case where the reselection button 644 of the display screen 640 is pressed, the terminal apparatus 40 determines that the reference information is to be reselected. On the other hand, in a case where the reselection button 644 of the display screen 640 is not pressed, the terminal apparatus 40 determines that the reference information is not to be reselected.

In the case where the reference information is to be reselected (YES), the terminal apparatus 40 displays the selection screen 630 again. The terminal apparatus 40 transmits a selection request to the report apparatus 10 according to a user operation on the selection screen 630. When the report apparatus 10 receives the selection request from the terminal apparatus 40, the report apparatus 10 returns the process to step S5. The terminal apparatus 40 may return the process to step S2, display the condition setting screen 620, and vary the search condition, to re-search for the reference condition. On the other hand, in the case where the reference information is not to be reselected (NO), the terminal apparatus 40 advances the process to step S10.

In step S10, a determination is made to determine whether or not to regenerate a report. Specifically, in a case where the regeneration button 643 of the display screen 640 is pressed, the terminal apparatus 40 determines that the report is to be regenerated. On the other hand, in a case where the regeneration button 643 of the display screen 640 is not pressed, the terminal apparatus 40 determines that the report is not to be regenerated.

In the case where the report is to be regenerated (YES), the terminal apparatus 40 displays the format specifying screen 600 again. The terminal apparatus 40 transmits a generation request to the report apparatus 10 according to a user operation on the format specifying screen 600. When the report apparatus 10 receives the generation request from the terminal apparatus 40, the report apparatus 10 returns the process to step S1. On the other hand, in the case where the report is not regenerated (NO), the terminal apparatus 40 ends the report generation process.

### Modification

The report generation process may be performed in the following manner.
(1) The user specifies the information related to the output format. The user may select one output format from a plurality of output formats. The output format may be determined in advance. The user may specify the information related to the output format through text editing or the like.
(2) The user specifies one or more pieces of reference information to be used for generating the output information. In this modification, the search for the reference information by the search unit 120 may be omitted. The user may specify one or more pieces of reference information through a drag-and-drop operation or the like. The method of specifying one or more pieces of reference information by the user may be the same as the method described above for receiving the input of the new reference information.
(3) The generation unit 150 generates input information to a machine learning model, based on the information related to the output format and one or more pieces of reference information specified by the user. The generation unit 150 generates the output information by inputting the generated input information to the machine learning model, and presents the output information to the user.
(4) The output unit 170 returns the process to (1) or (2), and generates another output information. The user may return the process to (1) or (2) in a case where the user desires to further improve the output information. The output unit 170 may generate difference information among a plurality of reports, and present the difference information to the user. The processes of (1) to (4) may be performed repeatedly until the specified by the user, or until a repetition number reaches a predetermined number.
(5) The output information finally selected by the user is output in a predetermined output format (for example, a PDF file or the like). The output format may be specified by the user in (1).

### Second Embodiment

According to the configuration of the first embodiment, the output format information related to all the items included in the report is included in the model input information, and the foundation model is caused to generate the output information indicating the entire report. In a second embodiment, a configuration will be described in which the output format information for each item included in the report is included in the model input information, the output information for each item is generated based on the foundation model, and the output information indicating the entire report is generated by integrating the output information for each item.

### Flow Chart of Report Generation Process

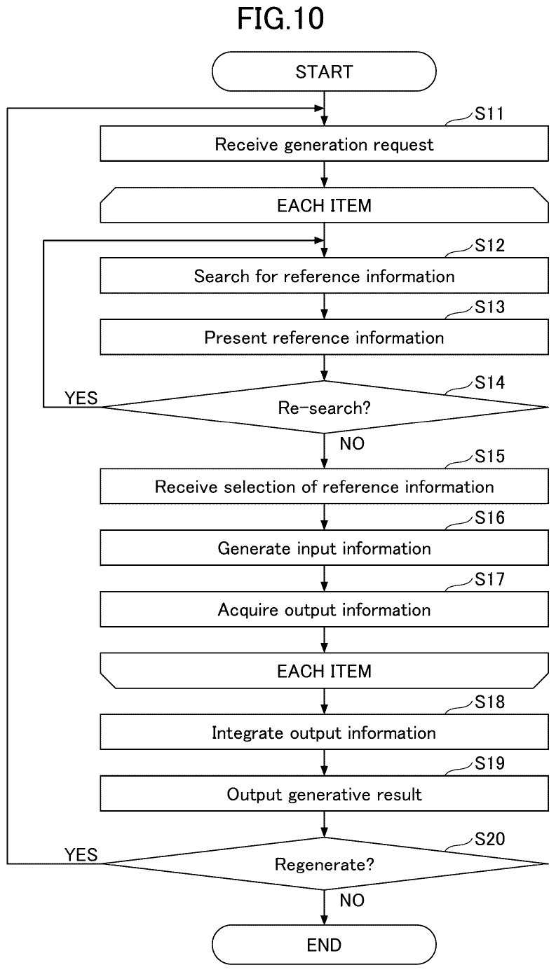

The report generation process according to the present embodiment will be described with reference to FIG. 10. FIG. 10 is a flow chart illustrating an example of the report generation process according to the second embodiment. The report generation process according to the present embodiment will be described below, focusing on the differences from the first embodiment.

In step S11, the request reception unit 110 of the report apparatus 10 receives the generation request from the terminal apparatus 40. The output format information and the user input information included in the generation request include information related to a plurality of items to be included in the report.

The generation request may include a search condition. The search condition may include at least one of a search condition for the entire report or a search condition for each item included in the report. The search condition included in the generation request may be set by an operation with respect to the condition setting screen 620.

In step S12, the search unit 120 of the report apparatus 10 selects one item from among the items included in the report. The items included in the report may be determined in advance or may not be determined in advance. In a case where the items included in the report are not determined, the user may specify the contents of the headings, the order of the headings, or the hierarchical information of the headings by a text input.

The search unit 120 may select an arbitrary item included in the report. For example, the search unit 120 may select a first item of the report. The first item of the report may be the title of the report, for example. The search unit 120 acquires the user input information and the search condition related to the selected item from the generation request.

The search unit 120 transmits a search request to the search apparatus 20 based on the acquired user input information and search condition. In a case where the search condition acquired from the generation request includes both the search condition related to the entire report and the search condition related to the items, the search unit 120 may generate the search request based on the search condition related to the item. In this case, the search unit 120 may generate a search request, based on each of the search condition related to the entire report and the search condition related to the item. In the case where the search is performed based on each of the search condition related to the entire report and the search condition related to the item, the list display part 631 of the selection screen 630 may display information indicating the search condition used to search each reference information.

The search apparatus 20 receives the search request from the report apparatus 10. The search apparatus 20 searches for the reference information from the data source 25 indicated in the search condition, based on the search request. The search apparatus 20 transmits the search result for the reference information to the report apparatus 10. The search unit 120 of the report apparatus 10 receives the search result for the reference information from the search apparatus 20. The search unit 120 sends the search result for the reference information to the presentation unit 130.

The processes from step S13 to step S15 is the same as the processes from step S3 to step S5 in the first embodiment. Similar to the first embodiment, the processes from step S13 to step S15 may be omitted.

In step S16, the generation unit 150 of the report apparatus 10 generates model input information, based on the output format information related to the item acquired in step S12 and the user input information, and the reference information acquired in step S15 (or the reference information included in the search result acquired in step S12). That is, the generation unit 150 generates the model input information for instructing generation of the output information for each item included in the report. The generation unit 150 transmits the generated model input information to the generative apparatus 30.

In step S17, the generative apparatus 30 inputs the model input information received from the report apparatus 10 to the foundation model 35. The foundation model 35 executes a predetermined task based on the model input information, and outputs output information generated as a result. The generative apparatus 30 transmits the output information output from the foundation model 35 to the report apparatus 10.

The generative apparatus 30 may generate the output information by inputting the model input information to a different foundation model for each item. The foundation model to be input with the model input information for each item may be determined based on an instruction from the user.

The generation unit 150 of the report apparatus 10 receives the output information from the generative apparatus 30. The received output information is output information corresponding to the item selected in step S12. The report apparatus 10 returns the process to step S12. When the process returns to step S12, the search unit 120 selects an arbitrary item for which the output information is not generated among the items included in the report. For example, the search unit 120 may select an item for which the output information is not generated in an order from a top of the report. The search unit 120 may select an item specified by the user.

Thereafter, the report apparatus 10 performs the processes from step S12 to step S17 again. Accordingly, the report apparatus 10 repeatedly performs the search for the reference information and the generation of the output information until the output information is acquired for all the items included in the report. When the generation unit 150 acquires the output information for all the items included in the report, the generation unit 150 sends the output information for each item acquired in step S17 to the output unit 170.

In step S18, the output unit 170 of the report apparatus 10 receives the output information for each item from the generation unit 150. The output unit 170 generates a report based on the output information for each item. The output unit 170 transmits a generative result including the generated report to the terminal apparatus 40. The report may include auxiliary information of the reference information used for generating the output information for each item.

The output unit 170 may generate a report by integrating the output information for each item. For example, the output unit 170 may generate the report by combining the output information for each item in the order acquired by the generation unit 150. In addition, the output unit 170 may generate the report by combining the output information for each item in the order of the items indicated by the output format information.

For example, the output unit 170 may integrate the output information for each item, based on the foundation model 35. Specifically, the output unit 170 may generate the model input information, based on configuration information of the items included in the report, and the output information for each item, and cause the foundation model 35 to generate the report based on the generated model input information. The configuration information is information indicating a configuration of the items included in the report. For example, the configuration information may be information listing the title and headings included in the report. The configuration information may be the output format information, or information obtained by processing the output format information. The output unit 170 may integrate the output information for each item based on another foundation model. The other foundation model may be a foundation model used for generating the output information for each item, or may be a foundation model different from the foundation model used for generating the output information for each item.

The output unit 170 may generate the model input information including the configuration information of the items included in the report, the report obtained by combining the output information for each item, and instruction information for instructing the formatting of the report, and cause the foundation model 35 to generate the report based on the generated model input information. The instruction information may include constraint information instructing the output information for each item to be maintained.

All of the configurations related to the information processing system 1000 according to the first embodiment can be applied to the information processing system 1000 according to the second embodiment. Similarly, all of the configurations related to the information processing system 1000 according to the second embodiment can be applied to the information processing system 1000 according to the first embodiment.

### Conclusion

As is evident from the description given heretofore, the information processing system according to the embodiment of the present disclosure acquires information related to an output format, searches for a plurality of pieces of reference information based on a search request, acquires one or more pieces of reference information used to generate output information based on a search result, generates input information to a machine learning model, based on the information related to the output format and the one or more pieces of reference information, and generates output information by inputting the input information to the machine learning model.

The information processing system may output information related to the search result, and acquire one or more pieces of reference information based on the user's selection. The information related to the search result may include at least one of a data source of the reference information, link information, at least a portion of the reference information, a summary, a thumbnail image, an owner, a copyright holder, a creation date, or a condition of use. The information processing system may acquire reference information other than the plurality of pieces of reference information as one or more pieces of reference information used for generating the output information, based on an instruction from the user.

The information related to the output format may include information related to one or more output formats selected from a plurality of output formats. The information related to the output format may include information related to a structure of the output information. The information related to the structure may include information related to one or more items to be included in the output information. The information related to one or more items may include information related to an item name and an item hierarchy included in the output information.

The search request may include at least one of a search condition or a query generated based on the user input information. The search condition may include at least one of a data source, a type, a creation date, or a condition of use for a search target. The information processing system may set the search condition based on the user information. The user information may include at least one of an authority, an attribute, an affiliation, a job title or position, or a subscription plan of the user.

The information processing system may acquire one or more pieces of other reference information used to generate second output information, based on the search result, generate second input information, based on information related to the output format and one or more pieces of other reference information, and generate the second output information by inputting the second input information to a machine learning model. The information processing system may output difference information between the output information and the second output information.

The information processing system may search for a plurality of pieces of other reference information, based on another search request, acquire one or more pieces of other reference information used for generating second output information, based on a search result for the plurality of pieces of other reference information, generate second input information to be input to a machine learning model, based on information related to the output format and the one or more pieces of other reference information, and generate second output information by inputting the second input information to the machine learning model. The information processing system may output difference information between the output information and the second output information.

The information processing system may output at least one of a data source, at least a portion of the reference information, a summary, a thumbnail image, an owner, a copyright holder, a creation date, or a condition of use for one or more pieces of reference information, together with the output information. The information processing system may output additional information related to the output information, before generating the output information. The additional information may include at least one of a time, a cost, or a computing resource required to generate the output information.

The information processing system may output the condition of use. The condition of use may include information indicating whether or not the use of the reference information is paid service. The information processing system may determine the cost required for generating or using the output information, based on at least the information indicating whether or not each of the one or more pieces of reference information is paid. The information processing system may output the determined cost before performing the process of generating the output information. In a case where the information processing system acquires a generation instruction from the user after outputting the determined cost, the information processing system may generate the output information by inputting input information to the machine learning model.

Thus, according to one embodiment of the present disclosure, a technique capable of acquiring desired output information can be provided. According to an aspect of one embodiment, it is possible to easily generate a report described in a desired output format.

### Hardware Configuration of Information Processing Apparatus

Each of the apparatuses (the report apparatus 10, the search apparatus 20, the generative apparatus 30, and the terminal apparatus 40) in the embodiments described above may be partially or entirely configured by hardware, or may be partially or entirely implemented by information processing of software (program) executed by a Central Processing Unit (CPU), a Graphics Processing Unit (GPU), or the like. In a case where the information processing is implemented by software, the software for implementing at least a part of the functions of the apparatuses in the embodiments described above may be stored in a non-transitory storage medium (non-transitory computer-readable storage medium), such as a Compact Disc-Read Only Memory (CD-ROM), a Universal Serial Bus (USB) memory, or the like, and a computer may read the software to perform the information processing of the software. In addition, the software may be downloaded via a communication network. Further, all or some of the processes of the software may be implemented in a circuit, such as an Application Specific Integrated Circuit (ASIC), a Field Programmable Gate Array (FPGA), or the like, and the information processing by the software may be implemented by hardware.

The storage medium for storing the software may be a removable storage medium, such as an optical disk or the like, or a fixed storage medium, such as a hard disk, a memory, or the like. The storage medium may be provided inside the computer (a main storage device, an auxiliary storage device, or the like) or may be provided outside the computer.

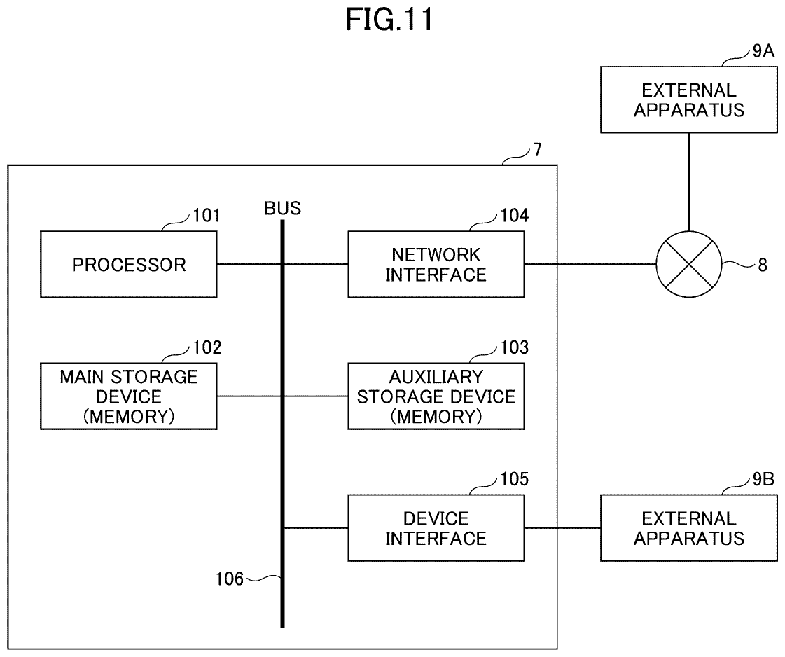

FIG. 11 is a block diagram illustrating an example of a hardware configuration of each of the apparatuses (the report apparatus 10, the search apparatus 20, the generative apparatus 30, and the terminal apparatus 40) in the embodiments described above. Each apparatus may be implemented by a computer 7 including a processor 71, a main storage device (memory) 72, an auxiliary storage device (memory) 73, a network interface 74, and a device interface 75, which are connected via a bus 76, for example.

The computer 7 illustrated in FIG. 11 includes one of each constituent element (or component), but may include a plurality of the same constituent elements. In addition, although a single computer 7 is illustrated in FIG. 11, the software may be installed in a plurality of computers, and the plurality of computers may perform processes by executing the same or different parts of the software. In this case, the computers may form a distributed computing system in which the computers communicate with one another via the network interface 74 or the like to perform the processes. That is, each of the apparatuses (the report apparatus 10, the search apparatus 20, the generative apparatus 30, and the terminal apparatus 40) in the embodiments described above may be configured as a system that implements the functions by one or a plurality of computers executing instructions stored in one or a plurality of storage devices. Further, the information transmitted from a terminal may be processed in one or a plurality of computers provided in a cloud, and the processed result may be transmitted to the terminal.

Various computations of the apparatuses (the report apparatus 10, the search apparatus 20, the generative apparatus 30, and the terminal apparatus 40) in the embodiments described above may be executed by parallel processing using one or a plurality of processors or by using a plurality of computers connected via a network. In addition, the various computations may be distributed to a plurality of processor cores within the processor and executed in parallel. Moreover, a part or all of the processes, means, or the like of the present disclosure may be implemented in at least one of a processor or a storage device provided in a cloud computing system capable of communicating with the computer 7 via a network. As described above, each apparatus in the embodiments described above may be in a form of a parallel computing system including one or a plurality of computers.

The processor 71 may be an electronic circuit (a processor circuit, a processing circuit, processing circuitry, a CPU, a GPU, an FPGA, an ASIC, or the like) that performs at least one of control or computation of the computer. In addition, the processor 71 may be one of a general-purpose processor, a dedicated processing circuit designed to execute a specific computation, and a semiconductor device including both the general-purpose processor and the dedicated processing circuit. Moreover, the processor 71 may include an optical circuit or may include a computation function based on quantum computing.

The processor 71 may perform the computing based on data and software input from each device or the like of an internal configuration of the computer 7, and may output a computation result or a control signal to each device or the like. The processor 71 may control each constituent element configuring the computer 7 by executing an Operating System (OS), an application program, or the like of the computer 7.

Each of the apparatuses (the report apparatus 10, the search apparatus 20, the generative apparatus 30, and the terminal apparatus 40) in the embodiments described above may be implemented by one or a plurality of processors 71. In this case, the processor 71 may refer to one or a plurality of electronic circuits disposed on a single chip, or may refer to one or a plurality of electronic circuits disposed on two or more chips or two or more devices. In a case where a plurality of electronic circuits are used, the electronic circuits may communicate with one another via a wired or wireless communication.

The main storage device 72 may store instructions to be executed by the processor 71, various data, or the like, and information stored in the main storage device 72 may be read by the processor 71. The auxiliary storage device 73 is a storage device other than the main storage device 72. These storage devices refer to arbitrary electronic components capable of storing electronic information, and may be semiconductor memories. The semiconductor memory may either be a volatile memory or a nonvolatile memory. The storage device for storing the various data or the like in each of the apparatuses (the report apparatus 10, the search apparatus 20, the generative apparatus 30, and the terminal apparatus 40) in the embodiments described above may be implemented by the main storage device 72 or the auxiliary storage device 73, or may be implemented by an internal or built-in memory of the processor 71. For example, each storage unit in the embodiments described above may be implemented by the main storage device 72 or the auxiliary storage device 73.

In a case where each of the apparatuses (the report apparatus 10, the search apparatus 20, the generative apparatus 30, and the terminal apparatus 40) in the embodiments described above is configured by at least one storage device (memory) and at least one processor connected (coupled) to the at least one storage device, the at least one processor may be connected to one storage device. In addition, at least one storage device may be connected to one processor. Moreover, the configuration may include at least one processor of the plurality of processors, connected to at least one storage device of the plurality of storage devices. Further, this configuration may be implemented by the storage device and the processor included in a plurality of computers. In addition, the storage device may have a configuration (for example, a cache memory including a L1 cache and a L2 cache) integrated with the processor.

The network interface 74 is an interface for connecting to the communication network 8 in a wireless connection or a wired (or cable) connection. The network interface 74 may be an appropriate interface, such as an interface conforming to an existing communication standard or the like. The network interface 74 may exchange information with an external apparatus 9A connected via the communication network 8. The communication network 8 may be any one of or a combination of a Wide Area Network (WAN), a Local Area Network (LAN), a Personal Area Network (PAN), or the like, and the communication network 8 may be any network capable of exchanging information between the computer 7 and the external apparatus 9A. Examples of the WAN include the Internet or the like, and examples of the LAN include IEEE 802.11, the Ethernet (registered trademark), or the like. Examples of the PAN include the Bluetooth (registered trademark), the Near Field Communication (NFC), or the like.

The device interface 75 is an interface, such as the Universal Serial Bus (USB) or the like, that connects directly to an external apparatus 9B.

The external apparatus 9A is an apparatus connected to the computer 7 via a network. The external apparatus 9B is an apparatus directly connected to the computer 7.

The external apparatus 9A or the external apparatus 9B may be an input device, for example. The input device is a device, such as a camera, a microphone, a motion capture, various sensors, a keyboard, a mouse, a touchscreen panel, or the like, for example, and provides acquired information to the computer 7. In addition, the input device may be a device including an input unit, a memory, and a processor, such as a personal computer, a tablet terminal, a smartphone, or the like.

Moreover, the external apparatus 9A or the external apparatus 9B may be an output device, for example. The output device may be a display device, such as a Liquid Crystal Display (LCD), an organic Electro Luminescence (EL) panel, or the like, for example. Further, the output device may be a speaker or the like that outputs sound or the like, for example. Further, the output device may be a device including an output unit, a memory, and a processor, such as a personal computer, a tablet terminal, a smartphone, or the like.

The external apparatus 9A or the external apparatus 9B may be a storage device (memory). For example, the external apparatus 9A may be a network storage or the like, and the external apparatus 9B may be a storage, such as a Hard Disk Drive (HDD) or the like.

Further, the external apparatus 9A or the external apparatus 9B may be an apparatus having the function of a part of the constituent elements of each of the apparatuses (the report apparatus 10, the search apparatus 20, the generative apparatus 30, and the terminal apparatus 40) in the embodiments described above. That is, the computer 7 may transmit a part or all of the processed result to the external apparatus 9A or the external apparatus 9B, or may receive a part or all of the processed result from the external apparatus 9A or the external apparatus 9B.

According to each of the embodiments and modifications, it is possible to provide a technique capable of acquiring desired output information

In this specification (including the claims), if the expression “at least one of a, b, and c” or “at least one of a, b, or c” is used (including similar expressions), any one of a, b, c, a-b, a-c, b-c, and a-b-c is included. Multiple instances may also be included in any of the elements, such as a-a, a-b-b, a-a-b-b-c-c, or the like. Further, the addition of another element other than the listed elements (that is, a, b, and c), such as adding d as a-b-c-d, is included.

In this specification (including the claims), if the expression such as “data as an input”, “using data”, “based on data”, “according to data”, or “in accordance with data” (including similar expressions) is used, a case where the data itself is used as an input and a case where data obtained by processing data (for example, data obtained by adding noise, normalized data, features extracted from data, intermediate representation of data, or the like) is used as an input are included, unless indicated otherwise. If it is described that any result can be obtained “data as an input”, “using data”, “based on data”, “according to data”, or “in accordance with data” (including similar expressions), a case where a result is obtained based on only the data is included, and a case where a result is obtained affected by another data other than the data, factors, conditions, and/or states may be included, unless indicated otherwise. If it is described that “data is output” (including similar expressions), a case where the data itself is used as an output is included, and a case where data obtained by processing data (for example, data obtained by adding noise, normalized data, features extracted from data, intermediate representation of data, or the like) is used as an output are included, unless indicated otherwise.

In this specification (including the claims), if the terms “connected” and “coupled” are used, the terms are intended as non-limiting terms that include any of direct, indirect, electrically, communicatively, operatively, and physically connected/coupled. Such terms should be interpreted according to a context in which the terms are used, but a connected/coupled form that is not intentionally or naturally excluded should be interpreted as being included in the terms without being limited.

In this specification (including the claims), if the expression “A configured to B” is used, a case where a physical structure of the element A has a configuration that can perform the operation B, and a permanent or temporary setting/configuration of the element A is configured/set to actually perform the operation B may be included. For example, if the element A is a general-purpose processor, the processor may have a hardware configuration that can perform the operation B and be configured to actually perform the operation B by setting a permanent or temporary program (that is, an instruction). If the element A is a dedicated processor or a dedicated arithmetic circuit, a circuit structure of the processor may be implemented so as to actually perform the operation B irrespective of whether the control instruction and the data are actually attached.

In this specification (including the claims), if a term indicating containing or possessing (for example, “comprising/including” and “having”) is used, the term is intended as an open-ended term, including an inclusion or possession of an object other than a target object indicated by the object of the term. If the object of the term indicating an inclusion or possession is an expression that does not specify a quantity or that suggests a singular number (that is, an expression using “a” or “an” as an article), the expression should be interpreted as being not limited to a specified number.

In this specification (including the claims), even if an expression such as “one or more” or “at least one” is used in a certain description, and an expression that does not specify a quantity or that suggests a singular number is used in another description (that is, an expression using “a” or “an” as an article), it is not intended that the latter expression indicates “one”. Generally, an expression that does not specify a quantity or that suggests a singular number (that is, an expression using “a” or “an” as an article) should be interpreted as being not necessarily limited to a particular number.

In this specification, if it is described that a particular advantage/result is obtained in a particular configuration included in an embodiment, unless there is a particular reason, it should be understood that that the advantage/result may be obtained in another embodiment or other embodiments including the configuration. It should be understood, however, that the presence or absence of the advantage/result generally depends on various factors, conditions, states, and/or the like, and that the advantage/result is not necessarily obtained by the configuration. The advantage/result is merely an advantage/result that results from the configuration described in the embodiment when various factors, conditions, states, and/or the like are satisfied, and is not necessarily obtained in the claimed invention that defines the configuration or a similar configuration.

In this specification (including the claims), if multiple hardware performs predetermined processes, each of the hardware may cooperate to perform the predetermined processes, or some of the hardware may perform all of the predetermined processes. Additionally, some of the hardware may perform some of the predetermined processes while another hardware may perform the remainder of the predetermined processes. In this specification (including the claims), if an expression such as “one or more hardware perform a first process and the one or more hardware perform a second process” is used, the hardware that performs the first process may be the same as or different from the hardware that performs the second process. That is, the hardware that performs the first process and the hardware that performs the second process may be included in the one or more hardware. The hardware may include an electronic circuit, a device including an electronic circuit, or the like.

In this specification (including the claims), if multiple storage devices (memories) store data, each of the multiple storage devices (memories) may store only a portion of the data or may store an entirety of the data. Further, some of the storage devices (memories) among the multiple storage devices (memories) may be configured to store the data.

In this specification (including the claims), the terms “first,” “second,” or the like are merely used as a method of distinguishing between two or more elements, and are not necessarily intended to impose technical significance such as temporal aspects, spatial aspects, order, quantity, or the like on the subjects. Accordingly, a reference to a first element and a second elements, for example, does not necessarily mean that only two elements may be employed, or that the first element must precede the second element, or that the first element must be present in order for the second element to be present, or the like.

Although the embodiments of the present disclosure have been described in detail above, the present disclosure is not limited to the individual embodiments described above. Various additions, modifications, substitutions, partial deletions, and the like may be made without departing from the conceptual idea and spirit of the invention derived from the contents defined in the claims and the equivalents thereof. For example, in all of the embodiments described above, if numerical values or mathematical expressions are used for description, they are presented as an example and are not limited thereto. Additionally, the order of respective operations in the embodiment is presented as an example and is not limited thereto.

In the disclosed technique, embodiments according to the following additional clauses are conceivable.

### Clause 1

An information processing system comprising:
at least one memory; and
at least one processor,
wherein the at least one processor is configured to:
   acquire information related to an output format;
   search for a plurality of pieces of reference information, based on a search request;
   acquire one or more pieces of reference information used for generating output information, based on a result of the search;
   generate input information to be input to a machine learning model, based on the information related to the output format and the one or more pieces of reference information; and
   generate the output information by inputting the input information to the machine learning model.

### Clause 2

The information processing system according to clause 1, wherein the at least one processor is configured to:
output information related to the result of the search; and
acquire the one or more pieces of reference information based on selection by a user.

### Clause 3

The information processing system according to clause 2, wherein the information related to the result of the search includes at least one of a data source, link information, at least a portion of the reference information, a summary, a thumbnail image, an owner, a copyright holder, a creation date, or a condition of use for the reference information.

### Clause 4

The information processing system according to clause 3, wherein the at least one processor is configured to:
acquire reference information other than the plurality of pieces of reference information as the one or more pieces of reference information used for generating the output information, based on an instruction from the user.

### Clause 5

The information processing system according to any one of clauses 1 to 4, wherein the information related to the output format includes information related to one or more output formats selected from a plurality of output formats.

### Clause 6

The information processing system according to clause 5, wherein the information related to the output format includes information related to a structure of the output information.

### Clause 7

The information processing system according to clause 6, wherein the information related to the structure includes information related to one or more items to be included in the output information.

### Clause 8

The information processing system according to clause 7, wherein the information related to the one or more items includes information related to an item name and a hierarchical structure of items to be included in the output information.

### Clause 9

The information processing system according to any one of clauses 1 to 8, wherein the search request includes at least one of a search condition or a query generated based on input information of a user.

### Clause 10

The information processing system according to clause 9, wherein the search condition includes at least one of a data source, a type, a creation date, or a condition of use for a search target.

### Clause 11

The information processing system according to clause 9 or 10, wherein the at least one processor is configured to:
set the search condition, based on user information.

### Clause 12

The information processing system according to clause 11, wherein the user information includes at least one of an authority, an attribute, an affiliation, a job title or position, or a subscription plan of the user.

### Clause 13

The information processing system according to any one of clauses 1 to 12, wherein the at least one processor is configured to:
acquire one or more pieces of other reference information used for generating second output information, based on the result of the search;
generate second input information, based on the information related to the output format and the one or more pieces of other reference information; and
generate the second output information by inputting the second input information to the machine learning model.

### Clause 14

The information processing system according to clause 13, wherein the at least one processor is configured to:
output difference information between the output information and the second output information.

### Clause 15

The information processing system according to any one of clauses 1 to 14, wherein the at least one processor is configured to:
search for a plurality of pieces of other reference information, based on another search request;
acquire one or more pieces of other reference information used for generating second output information, based on a result of the search for the plurality of pieces of other reference information;
generate second input information to be input to the machine learning model, based on the information related to the output format and the one or more pieces of other reference information; and
generate the second output information by inputting the second input information to the machine learning model.

### Clause 16

The information processing system according to clause 15, wherein the at least one processor is configured to:
output difference information between the output information and the second output information.

### Clause 17

The information processing system according to any one of clauses 1 to 16, wherein the at least one processor is configured to:
output at least one of a data source, at least a portion of the reference information, a summary, a thumbnail image, an owner, a copyright holder, a creation date, or a condition of use for the one or more pieces of reference information, together with the output information.

### Clause 18

The information processing system according to any one of clauses 1 to 17, wherein the at least one processor is configured to:
output additional information related to the output information, before generating the output information.

### Clause 19

The information processing system according to clause 18, wherein the additional information includes at least one of a time, a cost, or a computing resource required to generate the output information.

### Clause 20

The information processing system according to clause 3 or 4, wherein the at least one processor is configured to:
output the condition of use,
wherein the condition of use includes information indicating whether use of the reference information is paid or free.

### Clause 21

The information processing system according to clause 20, wherein the at least one processor is configured to:
determine a cost required for generating or using the output information, based on at least information indicating whether each of the one or more pieces of reference information is paid or free.

### Clause 22

The information processing system according to clause 21, wherein the at least one processor is configured to:
output the determined cost, before performing a process of generating the output information.

### Clause 23

The information processing system according to clause 22, wherein the at least one processor is configured to:
generate the output information is generated by inputting the input information to the machine learning model, in a case were a generation instruction is acquired from a user after outputting the determined cost.

### Clause 24

An information processing apparatus comprising:
at least one memory; and
at least one processor,
wherein the at least one processor is configured to:
   display, on a display device, information for specifying an output format;
   display, on the display device, a result of searching for a plurality of pieces of reference information based on a search request;
   display, on the display device, information for selecting one or more pieces of reference information from the plurality of pieces of reference information; and
   display, on the display device, output information generated by inputting input information to be input to a machine learning model, generated based on information related to the specified output format and the selected one or more pieces of reference information, to the machine learning model.

### Clause 25

The information processing apparatus according to clause 24, wherein the at least one processor is configured to:
display, on the display device, at least one of a data source, link information, at least a portion of the reference information, a summary, a thumbnail image, an owner, a copyright holder, a creation date, or a condition of use for the reference information, as a result of searching for the plurality of pieces of reference information.

### Clause 26

The information processing apparatus according to clause 25, wherein the at least one processor is configured to:
display, on the display device, information for specifying reference information other than the plurality of pieces of reference information.

### Clause 27

The information processing apparatus according to any one of clauses 24 to 26, wherein the at least one processor is configured to:
display, on the display device, information for selecting the output format from a plurality of output formats.

### Clause 28

The information processing apparatus according to any one of clauses 24 to 27, wherein the at least one processor is configured to:
display, on the display device, at least one of a data source, at least a portion of the reference information, a summary, a thumbnail image, an owner, a copyright holder, a creation date, or a condition of use for the one or more pieces of reference information, together with the output information.

### Clause 29

The information processing apparatus according to any one of clauses 24 to 28, wherein the at least one processor is configured to:
display, on the display device, information indicating whether or not each piece of reference information of the plurality of pieces of reference information is selected, as information for selecting the one or more pieces of reference information from the plurality of pieces of reference information.

### Clause 30

The information processing apparatus according to clause 26, wherein the at least one processor is configured to:
display, on the display device, information related to a drag-and-drop operation, as information for specifying reference information other than the plurality of pieces of reference information.

### Clause 31

An information processing system comprising:
at least one memory; and
at least one processor,
wherein the at least one processor is configured to:
   acquire a first search request for a first item;
   search for a plurality of pieces of first reference information, based on the first search request;
   acquire one or more pieces of first reference information used for generating first output information, based on a result of the search based on the first search request;
   generate first input information to be input to a machine learning model, based on the information related to the first item and the one or more pieces of first reference information;
   generate the first output information by inputting the first input information to the machine learning model;
   acquire a second search request for a second item;
   search for a plurality of pieces of second reference information, based on the second search request;
   acquire one or more pieces of second reference information used for generating second output information, based on a result of the search based on the second search request;
   generate second input information to be input to the machine learning model, based on information related to the second item and the one or more pieces of second reference information;
   generate the second output information by inputting the second input information to the machine learning model; and
   generate third output information, based on the first output information and the second output information.

### Clause 32

The information processing system according to clause 31, wherein the at least one processor is configured to:
output information related to the result of the search based on the first search request;
acquire the one or more pieces of first reference information, based on selection by a user;
output information related to the result of the search based on the second search request; and
acquire the one or more pieces of second reference information, based on the selection by the user.

### Clause 33

The information processing system according to clause 31 or 32, wherein the at least one processor is configured to:
generate third input information to be input to the machine learning model, based on the first output information and the second output information; and
generate the third output information by inputting the third input information to the machine learning model.

### Clause 34

An information processing method in which at least one processor performs a process including:
acquiring information related to an output format;
searching for a plurality of pieces of reference information, based on a search request;
acquiring one or more pieces of reference information used for generating output information, based on a result of the search;
generating input information to be input to a machine learning model, based on the information related to the output format and the one or more pieces of reference information; and
generating the output information by inputting the input information to the machine learning model.

### Clause 35

An information processing method in which at least one processor performs a process including:
displaying, on a display device, information for specifying an output format;
displaying, on the display device, a result of searching for a plurality of pieces of reference information based on a search request;
displaying, on the display device, information for selecting one or more pieces of reference information from the plurality of pieces of reference information; and
displaying, on the display device, output information generated by inputting input information to be input to a machine learning model, generated based on information related to the specified output format and the selected one or more pieces of reference information, to the machine learning model.

### Clause 36

An information processing method in which at least one processor performs a process including:
acquiring a first search request for a first item;
searching for a plurality of pieces of first reference information, based on the first search request;
acquiring one or more pieces of first reference information used for generating first output information, based on a result of a search based on the first search request;
generating first input information to be input to a machine learning model, based on information related to the first item and the one or more pieces of first reference information;
generating the first output information by inputting the first input information to the machine learning model;
acquiring a second search request for a second item;
searching for a plurality of pieces of second reference information, based on the second search request;
acquiring one or more pieces of second reference information used for generating second output information, based on a result of a search based on the second search request;
generating second input information to be input to the machine learning model, based on information related to the second item and the one or more pieces of second reference information;
generating the second output information by inputting the second input information to the machine learning model; and
generating third output information based on the first output information and the second output information.

### Clause 37

A program for causing at least one processor configured to perform a process including:
acquiring information related to an output format;
searching for a plurality of pieces of reference information, based on a search request;
acquiring one or more pieces of reference information used for generating output information, based on a result of the search;
generating input information to be input to a machine learning model, based on the information related to the output format and the one or more pieces of reference information; and
generating the output information by inputting the input information to the machine learning model.

### Clause 38

A program for causing at least one processor to perform a process including:
displaying, on a display device, information for specifying an output format;
displaying, on the display device, a result of searching for a plurality of pieces of reference information based on a search request;
displaying, on the display device, information for selecting one or more pieces of reference information from the plurality of pieces of reference information; and
displaying, on the display device, output information generated by inputting input information to be input to a machine learning model, generated based on information related to the specified output format and the selected one or more pieces of reference information, to the machine learning model.

### Clause 39

A program for causing at least one processor to perform a process including:
acquiring a first search request for a first item;
searching for a plurality of pieces of first reference information, based on the first search request;
acquiring one or more pieces of first reference information used for generating first output information, based on a result of a search based on the first search request;
generating first input information to be input to a machine learning model, based on information related to the first item and the one or more pieces of first reference information;
generating the first output information by inputting the first input information to the machine learning model;
acquiring a second search request for a second item;
searching for a plurality of pieces of second reference information, based on the second search request;
acquiring one or more pieces of second reference information used for generating second output information, based on a result of a search based on the second search request;
generating second input information to be input to the machine learning model, based on information related to the second item and the one or more pieces of second reference information;
generating the second output information by inputting the second input information to the machine learning model; and
generating third output information based on the first output information and the second output information.

What is claimed is:

1. An information processing system comprising:
at least one memory; and
at least one processor,
wherein the at least one processor is configured to:
acquire one or more pieces of reference information used for generating output information, based on user information;
generate input information to a machine learning model, based on the one or more pieces of reference information; and
generate the output information by inputting the input information to the machine learning model.

2. The information processing system as claimed in claim 1, wherein the at least one processor is configured to:
set a search condition for searching for the one or more pieces of reference information, based on the user information.

3. The information processing system as claimed in claim 2, wherein the user information includes at least one of an authority, an attribute, an affiliation, a job title or position, or a subscription plan of a user.

4. The information processing system as claimed in claim 1, wherein the at least one processor is configured to:
search for a plurality of pieces of reference information;
output information related to a result of the search; and
acquiring the one or more pieces of reference information based on a selection by a user.

5. The information processing system as claimed in claim 4, wherein the at least one processor is configured to:
set at least one piece of reference information of the plurality of pieces of reference information selectable by the user, based on the user information.

6. The information processing system as claimed in claim 5, wherein the user information includes at least one of an authority, an attribute, an affiliation, a job title or position, or a subscription plan of the user.

7. The information processing system as claimed in claim 4, wherein the at least one processor is configured to:
acquire one or more pieces of other reference information used for generating second output information, based on the user information;
generate second input information, based on the one or more pieces of other reference information; and
generate the second output information by inputting the second input information to the machine learning model.

8. The information processing system as claimed in claim 7, wherein the at least one processor is configured to:
output difference information between the output information and the second output information.

9. The information processing system as claimed in claim 4, wherein the at least one processor is configured to:
acquire reference information other than the plurality of pieces of reference information as the one or more pieces of reference information used for generating the output information, based on an instruction from the user.

10. The information processing system as claimed in claim 4, wherein the at least one processor is configured to:
search for the plurality of pieces of reference information, based on at least one of a search condition or a query generated based on input information of the user.

11. The information processing system as claimed in claim 1, wherein the at least one processor is configured to:
search for a plurality of pieces of reference information; and
output information related to a result of the search, and
the information related to the search result includes at least one of a data source, link information, at least a portion of the reference information, a summary, a thumbnail image, an owner, a copyright holder, a creation date, or a condition of use for at least one piece of reference information of the plurality of pieces of reference information.

12. The information processing system as claimed in claim 11, wherein the at least one processor is configured to:
output at least the condition of use, and
the condition of use includes information indicating whether use of the at least one piece of reference information of the plurality of pieces of reference information is paid or free.

13. The information processing system as claimed in claim 12, wherein the at least one processor is configured to:
determine a cost required for generating or using the output information, based on at least information indicating whether each of the one or more pieces of reference information is paid or free.

14. The information processing system as claimed in claim 1, wherein the at least one processor is configured to:
acquire information related to an output format; and
generate the input information to be input to the machine learning model, based on the information related to the output format and the one or more pieces of reference information.

15. The information processing system as claimed in claim 14, wherein the information related to the output format includes information related to one or more output formats selected from a plurality of output formats.

16. The information processing system as claimed in claim 14, wherein the information related to the output format includes information related to a structure of the output information.

17. The information processing system as claimed in claim 15, wherein the information related to the structure includes information related to one or more items to be included in the output information.

18. The information processing system as claimed in claim 1, wherein the at least one processor is configured to:
output additional information related to the output information, before generating the output information, and
the additional information includes at least one of a time, a cost, or a computing resource required to generate the output information.

19. An information processing method in which at least one processor performs a process including:
acquiring one or more pieces of reference information used for generating output information based on user information;
generating input information to a machine learning model based on the one or more pieces of reference information; and
generating the output information by inputting the input information to the machine learning model.

20. A non-transitory computer-readable storage medium having stored therein a program which, when executed by at least one processor, causes the at least one processor to perform a process including:
acquiring one or more pieces of reference information used for generating output information based on user information;
generating input information to a machine learning model based on the one or more pieces of reference information; and
generating the output information by inputting the input information to the machine learning model.
